(19) United States
(12) Patent Application Publication
(10) Pub. No.: US 2024/0342633 A1
(43) Pub. Date: Oct. 17, 2024

(54) FILTER ARRANGEMENTS FOR LIQUIDS AND METHODS OF USE

(71) Applicant: Donaldson Company, Inc., Bloomington, MN (US)

(72) Inventors: Andrew F. Johnson, Eden Prairie, MN (US); Michael J. Gustafson, Minnetonka, MN (US); Brent L. Anderson, Cottage Grove, MN (US); Timothy D. Sporre, Brooklyn Park, MN (US)

(21) Appl. No.: 18/634,735

(22) Filed: Apr. 12, 2024

Related U.S. Application Data
(60) Provisional application No. 63/459,464, filed on Apr. 14, 2023.
(60) Provisional application No. 63/459,480, filed on Apr. 14, 2023.

(51) Int. Cl. B01D 29/33; B01D 29/11; B01D 29/35; B01D 35/30

(52) U.S. Cl. CPC B01D 29/333; B01D 29/111; B01D 29/353; B01D 35/30; B01D 2201/12; B01D 2201/295; B01D 2201/347; B01D 2201/4076; B01D 2201/4092

(57) ABSTRACT

A filter assembly includes: a filter cartridge having filter media and a first end cap holding an axially disposed seal member, an end arrangement sized to engage against the filter cartridge and form a seal with the seal member, and an anti-rotation arrangement constructed and arranged to prevent the filter cartridge and cover arrangement from rotation relative to each other.

### RELATED APPLICATIONS

This application claims priority to U.S. Provisional Patent Application No. 63/459,464, filed Apr. 14, 2023 and to U.S. Provisional Patent Application No. 63/459,480, filed Apr. 14, 2023, the entireties of which are incorporated by reference herein.

### TECHNICAL FIELD

This disclosure relates generally to liquid filters and methods. The example embodiments described include bowl-cartridge assemblies and in-tank filter assembly, for use, for example, in oil or hydraulic systems.

### BACKGROUND

Liquid filters are employed in a variety of applications, including, for example, hydraulic systems, fuel systems, and engine lubrication systems.

In general, liquid filters which accommodate downstream components, are of concern. Particularly, it is of concern to prevent cavitation of pumps and other equipment downstream from liquid filters. Conditions such as cold starts, flow surges, or occluded elements can result in damaged downstream components.

Continued improvements are desired.

### SUMMARY

In an aspect, a filter assembly is provided comprising: (a) a filter element having filter media; (b) an end arrangement removably positionable over the filter element; (c) a first abutment member and a second abutment member capable of abutting when the assembly is in a first condition and prevented from abutting when the assembly is in a second condition; and (d) a transition arrangement to enable transition of the assembly between the first condition and second condition.

In example embodiments:
the first abutment member includes a radially flexible member.
the first abutment member includes an axially rigid member.
the transition arrangement is mechanically associated with the filter element.
the first abutment member includes a spiral spring, and/or flat spring, and/or clock spring.
the first abutment member is a flat spring shaped to form a partial enclosure.
the transition arrangement includes a ramp on the filter element.
the filter element has a first end and an opposite second end, and the ramp arrangement projects radially from the first end.
the ramp arrangement is configured to radially adjust the radially flexible member when forced against the ramp arrangement in a direction from the first end to the second end.
the first condition includes the radially flexible member having a first outermost dimension, and the second condition includes the radially flexible member having a second outermost dimension, and wherein the first outermost dimension is smaller than the second outermost dimension.
the first condition includes the radially flexible member having a first outermost dimension, and the second condition includes the radially flexible member having a second outermost dimension, and wherein the first outermost dimension is larger than the second outermost dimension.
the first abutment member is connected to the end arrangement.
the end arrangement is one of a filter head or a cover.
the transition arrangement radially adjusts the first abutment member to prevent abutment of the first abutment member against the second abutment member.
the second abutment member is part of a housing arrangement sized to receive the filter element.
the housing arrangement includes a strainer arrangement having an open interior, the open interior constructed and arranged to receive the filter element.
the strainer arrangement has a first end cap, the first end cap including the second abutment member.
the housing arrangement includes a filter bowl having an open interior, the open interior constructed and arranged to receive the filter element.
the first abutment member is connected to the end arrangement.

In an aspect, a filter assembly is provided comprising: (a) an end arrangement; (b) a first abutment member in the filter assembly that is radially movable; and (c) a filter cartridge including: (i) a tubular media pack defining an open media interior, the tubular media pack having a first end and an opposite second end; (ii) a central longitudinal axis centered within the tubular media pack and passing through the first end and second end; and (iii) a displacement member sized and positioned to engage against the first abutment member to move the first abutment member radially when the filter cartridge is connected to the end arrangement.

In example embodiments:
the displacement member includes a ramp arrangement.
the displacement member includes a living hinge that pivots against the first abutment member.
the ramp arrangement includes a ramp surface angled at a non-zero and non-perpendicular angle relative to the longitudinal axis.
the ramp surface is angled between 5 to 80 degrees.
the ramp surface is angled between 15 to 70 degrees.
the ramp surface is angled about 20 to 30 degrees.
the filter cartridge has a first end cap fixed to the first end of the tubular media pack, and the ramp surface is an integral part of the first end cap.
the first end cap has an outer radial surface defining the ramp surface.
the ramp surface has a leading free end and a trailing end;
the leading free end projects axially away from a remaining part of the filter cartridge and toward the filter head; and the trailing end being along an outer periphery of the first end cap.
the end arrangement includes a filter head and a cover arrangement, the filter head having: (a) a wall surrounding an open interior and fluid channels; and (b) a first fastener arrangement along the wall, the wall having opposite first and second ends, each of the first and second ends being open.
the cover arrangement is sized to be removably positioned within the interior of the filter head, the cover arrangement including: (i) a central hub circumscribing a fluid conduit in communication with the fluid channels of the filter head; (ii) a second fastener arrangement constructed and arranged for removable connection with the first fastener arrangement; wherein when the cover arrangement is positioned over the first cartridge, the displacement member moves the first abutment member radially to allow the second fastener arrangement of the cover arrangement to connect to the first fastener arrangement of the filter head.
the end arrangement includes a filter head, the filter head having: (a) a wall surrounding an open interior and fluid channels; and (b) a first fastener arrangement along the wall, the wall having opposite first and second ends, the second end being open and sized to connect with a filter bowl.
the end arrangement further includes a filter bowl having an open interior, the open interior constructed and arranged to receive the filter element, the filter bowl having a second fastener arrangement removably connecting to the first fastener arrangement.
the filter cartridge includes a seal member positioned to form a seal with the end arrangement; and the first end cap has an outer axial surface holding the seal member.
the first end cap is an open end cap.
the filter cartridge further includes a second end cap fixed to the second end of the tubular media pack.
the second end cap is a closed end cap.
the second end cap is an open end cap.
the tubular media pack is an inner tubular media pack; and the filter cartridge further includes an outer tubular media pack radially spaced from and circumscribing the inner tubular media pack.
the inner tubular media pack comprises pleated media; and the outer tubular media pack comprises pleated media.
the outer tubular media pack has a first end and an opposite second end; and the first end cap is fixed to the first end of the outer tubular media pack.
the inner tubular media pack has an axial length greater than an axial length of the outer tubular media pack; and the inner tubular media pack first end is closer to the cover arrangement than the outer tubular media pack first end.
the filter cartridge further includes an outer liner surrounding the outer tubular media pack; the outer liner extending between the first end cap and an opposite second end cap.
the first abutment member is secured to the end arrangement.
the first abutment member circumscribes a central hub in the end arrangement.
the first abutment member comprises an axially rigid and radially flexible spring that moves radially in response to force against the spring by the displacement member.
the first abutment member comprises a flat spring that moves radially when engaged against the ramp surface and when free of contact with the ramp surface.
the end arrangement includes a cover arrangement with a plurality of posts projecting from the central hub; and the spring is slidably mounted on the plurality of posts.
the end arrangement includes a filter head having a surrounding wall with a plurality of posts projecting from the surrounding wall into the interior of the filter head; and the spring is slidably mounted on the plurality of posts.
the cover arrangement includes: (a) a closed cover member having an outer radial surface defining the second fastener arrangement; (b) a sealing ring axially spaced from the cover member, the sealing ring holding a radially oriented seal member positioned to form a seal with the filter head; (c) the sealing ring having a first axial surface and an opposite second axial surface, the first axial surface facing the cover member; and (d) the central hub extending from the second axial surface.
the central hub has an outer diameter that is 50 to 80% of an outer diameter of the sealing ring.
the radially oriented seal member of the sealing ring is outwardly directed.
the first fastener arrangement and second fastener arrangement are threads.
the first abutment member is radially movable between an innermost position to an outermost position, the innermost position having a dimension D1, and the outermost position having a dimension D2; and a ratio of D1:D2 is between 0.74 and 0.98.

In an aspect, a filter cartridge is provided comprising: (a) a tubular media pack defining an open media interior, the tubular media pack having a first end and an opposite second end; a central longitudinal axis centered within the tubular media pack and passing through the first end and second end; and a displacement arrangement secured to the media pack, the displacement arrangement including at least one engagement projection having a leading edge and a trailing edge.

In example embodiments:
the leading edge is closer to the central longitudinal axis than the trailing edge.
the trailing edge is closer to the central longitudinal axis than the leading edge.
the displacement arrangement comprises a plurality of engagement projections.
the tubular media pack is cylindrical.
a straight line extending between the leading edge and trailing edge for at least one or a plurality of engagement projections is angled at a non-zero and non-perpendicular angle relative to the longitudinal axis.
the straight line extending between the leading edge and trailing edge is angled between one of 5 to 80 degrees, or 15 to 70 degrees, or 20 to 30 degrees.
the at least one or plurality of engagement projections is straight.
the at least one or plurality of engagement projections is not straight.
there is only one engagement projection forming a radially continuous surface.
the radially continuous surface of the engagement projection circumscribes the media pack.
the at least one or plurality of engagement projections comprises a ramp.
the ramp is angled between any one of 5 to 80 degrees, or 15 to 70 degrees, or 20 to 30 degrees.
the ramp is angled between any one of 100 to 175 degrees, or 105 to 165 degrees, or 150 to 160 degrees.
the filter cartridge has a first end cap fixed to the first end of the tubular media pack, and the at least one or plurality of engagement projections is an integral part of the first end cap.
the first end cap has an outer radial surface defining the at least one or plurality of engagement projections.
the filter cartridge includes a seal member positioned to form a seal with a cover arrangement; and the first end cap has an outer axial surface holding the seal member.
the first end cap is an open end cap.
the filter cartridge further includes a second end cap fixed to the second end of the tubular media pack.
the filter cartridge further includes an outer liner surrounding the tubular media pack, the outer liner extending between the first end cap and an opposite second end cap.
the displacement arrangement extends to a distal end having a stepped cross-sectional profile defining at least one radially facing surface and at least one axially facing surface.
the at least one radially facing surface is an outwardly facing radial surface.
the at least one radially facing surface is an inwardly facing radial surface.
the stepped cross-sectional profile includes a single step.
the stepped cross-sectional profile includes a plurality of steps.
the distal end further includes an axial extension radially inset from the stepped cross-sectional profile.

In an aspect, a method of servicing a filter assembly, the filter assembly including an end arrangement and a filter cartridge; the method comprising: (a) moving the end arrangement having a first abutment member against a displacement member to radially move the first abutment member; and (b) sealingly engaging the end arrangement with the filter cartridge.

Example methods include:
moving the first abutment member against the displacement member includes moving the first abutment member against a ramp arrangement.
moving the first abutment member against the displacement member includes moving the first abutment member against a living hinge.
the filter cartridge has a first end cap; and wherein moving the first abutment member against the displacement member includes moving the first abutment member against the displacement member that is an integral part of the first end cap.
radially moving the first abutment member includes moving the first abutment member radially outwardly.
radially moving the first abutment member includes moving the first abutment member radially inwardly.
radially moving the first abutment member includes radially moving an axially rigid and radially flexible spring.
moving the end arrangement includes moving a cover arrangement holding the first abutment member.
moving the end arrangement includes moving a filter head holding the first abutment member.

In an aspect, a filter assembly is provided comprising: (a) a filter cartridge having filter media and a first end cap holding an axially disposed seal member; (b) an end arrangement sized to engage against the filter cartridge and form a seal with the seal member; and (c) an anti-rotation arrangement constructed and arranged to prevent the filter cartridge and cover arrangement from rotation relative to each other.

In example embodiments:
the end arrangement comprises a cover.
the cover is removably received within the filter head.
the end arrangement comprises a filter head.
the anti-rotation arrangement includes a projection and receiver arrangement.
the projection and receiver arrangement are positioned to provide less than full radial support to the seal member.
the seal member is supported along at least some locations along an inner, or outer, or both inner and outer, radial side of the seal member.
the anti-rotation arrangement includes a first assembly on the filter cartridge and a second assembly on the end arrangement.
the first assembly of the anti-rotation arrangement includes: (a) an outer ring of projections and receivers circumscribing the seal member; (b) each of the projections in the outer ring defines a closed area; (c) each of the receivers in the outer ring defines an open area; and (d) a ratio of the open area to the closed area is 0.2-1.
the second assembly of the anti-rotation arrangement includes: (a) a first hub ring of projections and receivers; (b) each of the projections in the first hub ring defines a closed area; (c) each of the receivers in the first hub ring defines an open area; and (d) a ratio of the open area of the first hub ring to the closed area of the first hub ring is 1-1.3.
the first assembly of the anti-rotation arrangement on the filter cartridge includes an inner ring of projections and receivers radially inward of the seal member such that the seal member is positioned between the outer ring and inner ring.
the second assembly of the anti-rotation arrangement on the end arrangement includes a second hub ring of projections and receivers radially inward of the first hub ring; wherein, when the end arrangement is engaged against the filter cartridge, the seal member is between the first hub ring and second hub ring.
the filter cartridge includes a cartridge thread; and the end arrangement includes an end arrangement thread positioned to rotatably engage the cartridge thread.
the first assembly and the second assembly of the anti-rotation arrangements are positioned to engage before the cartridge thread and end arrangement threads engage.
the filter media includes a cylindrical extension of pleated media surrounding an open filter interior and extending between the first end cap and a second end cap; and the first end cap has an aperture in communication with the open filter interior.

In an aspect, a filter assembly is provided comprising: (a) an end arrangement including: (i) a hub having a surrounding wall circumscribing an opening; (ii) the surrounding wall having a terminal axial surface; (iii) a hub outer ring of circumferentially spaced projections; and (b) a filter cartridge having filter media and an end cap arrangement holding a seal member; the end cap arrangement nesting with the hub outer ring to rotationally secure the filter cartridge and end arrangement.

In example embodiments:
the filter cartridge end cap arrangement includes an outer ring projection arrangement nesting with the hub outer ring of circumferentially spaced projections, the outer ring projection arrangement of the filter cartridge being positioned to radially support the seal member.
the hub further includes a hub inner ring of circumferentially spaced projections, the hub inner ring being radially spaced from and surrounded by the hub outer ring.
the filter cartridge end cap arrangement includes an inner ring projection arrangement, the inner ring projection arrangement being radially inward of and spaced from the outer ring projection arrangement; wherein the seal member is between the outer ring projection arrangement and inner ring projection arrangement.
the outer ring projection arrangement on the filter cartridge comprises a plurality of circumferentially spaced outer cogs; and the inner ring projection arrangement on the filter cartridge comprises a plurality of circumferentially spaced inner cogs; the outer cogs are sized to nest between the hub outer ring projections; and the inner cogs are sized to nest between the hub inner ring projections.
the number of hub outer ring projections is different from the number of the spaced outer cogs on the filter cartridge.
the number of hub outer ring projections is less than the number of spaced outer cogs on the filter cartridge.
the number of hub inner ring projections is different from the number spaced inner cogs on the filter cartridge.
the number of the hub inner ring projections is less than the number of the spaced inner cogs on the filter cartridge.
the number of hub outer ring projections is equal to the number of spaced outer cogs on the filter cartridge; and the number of hub inner ring projections is equal to the number of spaced inner cogs on the filter cartridge.
the number of hub outer ring projections is equal to the number of the hub inner ring projections.
the number of hub outer ring projections is different from the number of the hub inner ring projections.
the number of spaced outer cogs on the filter cartridge is equal to the number of spaced inner cogs on the filter cartridge.
the number of spaced outer cogs on the filter cartridge is different from the number of spaced inner cogs on the filter cartridge.
the filter media includes a cylindrical extension of pleated media surrounding an open filter interior and extending between a first end cap and a second end cap; and the end cap arrangement is an integral one-piece part of the first end cap.
the first end cap has an aperture in communication with the open filter interior; the end cap arrangement is on an axial portion of the first end cap and circumscribes the aperture; and the opening in the hub is in communication with the aperture of the first end cap and the open filter interior.
a housing removably holding the filter cartridge, the housing having a housing threaded section; and the end arrangement having an end arrangement threaded section positioned to be connected to the housing threaded section.
there is a distance D1 between a start of the housing threaded section and end tips of the projection arrangement; there is a distance D2 between a start of the end arrangement threaded section and end tips of the projections; and the distance D1 is greater than the distance D2.

In another aspect, a filter cartridge is provided comprising: (a) a tubular media pack defining an open media interior, the tubular media pack having a first end and an opposite second end; (b) a central longitudinal axis centered within the tubular media pack and passing through the first end and second end; (c) an end arrangement secured to the first end of the tubular media pack; (d) a seal member secured to an axial portion of the end arrangement within a plane orthogonal to the central longitudinal axis; and (e) an anti-rotation arrangement to minimize bunching of the seal element when the filter cartridge is secured to one of a filter cover or filter head.

In examples:
the anti-rotation arrangement is secured to or integral with the end arrangement.
the anti-rotation arrangement is located on the axial portion of the end arrangement adjacent to the seal member.
the anti-rotation arrangement includes a plurality of projections located between the seal member and an outer periphery of the end arrangement.
the plurality of projections are separated by receivers arranged on an outer ring circumscribing the seal member.
each of the projections in the outer ring of projections defines a closed area; each of the receivers in the outer ring of receivers defines an open area; and a ratio of the open area to the closed area is 0.2-1.0.
the end arrangement further includes an inner series of circumferentially spaced projections separated by receivers arranged on an inner ring; the inner ring being radially inward of and spaced from the outer ring; and the seal member is between the outer ring and inner ring.
each of the projections in the inner ring of projections defines a closed area; each of the receivers in the inner ring of receivers defines an open area; and a ratio of the open area for the inner ring to the closed area of the inner ring is 0.2-1.0.
the end arrangement comprises a first end cap secured to the first end of the media pack; the first end cap has a first axial surface oriented away from the media pack and a second axial surface oriented toward the media pack; and the outer ring, inner ring, and seal member are on the first axial surface.
the first end cap has an open aperture in communication with the open media interior.
the inner ring is radially spaced from and circumscribes the open aperture.
the outer ring is along an outer edge of the first end cap.
a number of projections in the outer ring of spaced projections is equal to a number of projections of the inner ring.
a number of projections in the outer ring of spaced projections is different from a number of projections of the inner ring.
each of the projections of the outer ring has a same shape as each of the projections of the inner ring.
each of the projections of the outer ring has a shape different than a shape as each of the projections of the inner ring.
each of the projections of the outer ring has a triangular shape.
each of the projections of the inner ring has a triangular shape.

In another aspect, a method of connecting a filter assembly to a filter end arrangement is provided; the filter end arrangement being one of a filter head or filter cover; the filter assembly including a filter cartridge removably mounted in a housing; the filter cartridge having a plurality of cartridge projections and receivers positioned to engage the filter end arrangement; the filter end arrangement having a plurality of end arrangement projections and receivers positioned to engage the filter cartridge; the method comprising: positioning the cartridge projections to be at least partially received within the end arrangement receivers, allowing the filter cartridge to move axially toward the end arrangement; after the filter cartridge moves axially toward the end arrangement, engaging a thread on the housing with a thread on the end arrangement; and rotating the housing relative to the end arrangement to threadably connect the filter assembly to the filter end arrangement.

In an example method, (a) the filter cartridge includes an axially mounted seal member adjacent to the cartridge projections and receivers; and (b) the step of connecting the filter assembly to the filter end arrangement includes radially supporting the seal member between the cartridge projections and the end arrangement projections.

In an example, a filter cartridge can include: a tubular media pack defining an open media interior, the tubular media pack having a first end and an opposite second end; a central longitudinal axis centered within the tubular media pack and passing through the first end and second end; an end cap secured to the first end of the tubular media pack; a seal member secured to an axial portion of the end cap; and a first plurality of projections extending in an axial direction from the end cap, the first plurality of projections being provided in a circumferential arrangement and located proximate a radial side of the seal member.

In some examples, the first plurality of projections circumscribes the seal member.

In some examples, the first plurality of projections is circumscribed by the seal member.

In some examples, the first plurality of projections extends axially beyond the seal member.

In some examples, each of the projections of the first plurality of projections has a similar geometry.

In some examples, the first plurality of projections includes one or more projections that are different from one or more other projections.

In some examples, the first plurality of projections has one of a triangular shape, a trapezoidal shape, a rectangular shape with flat, rounded, or pointed ends, and a curved shape.

In some examples, the first plurality of projections has a symmetrical shape.

In some examples, the first plurality of projections has an asymmetrical shape.

In some examples, the first plurality of projections is separated by a first plurality of receiver gaps.

In some examples, each of the receiver gaps of the first plurality of receiver gaps has a similar geometry.

In some examples, the first plurality of receiver gaps includes one or more receiver gaps that are different from one or more other receiver gaps.

In some examples, each of the projections of the first plurality of projections has a similar geometry, wherein each of the receiver gaps of the first plurality of receiver gaps has a similar geometry.

In some examples, the circumferential arrangement includes a circumferentially arranged second plurality of projections.

In some examples, the first plurality of projections circumscribes the seal member and the seal member circumscribes the second plurality of projections.

In some examples, peaks of the first plurality of projections are radially aligned with peaks of the second plurality of projections.

In some examples, peaks of the first plurality of projections are radially misaligned with peaks of the second plurality of projections.

In some examples, the projections of the first plurality of projections have a geometry that is similar to a geometry to the projections of the second plurality of projections.

In some examples, the projections of the first plurality of projections have a geometry that is dissimilar to a geometry of the projections of the second plurality of projections.

One example method of connecting a filter assembly to a filter end arrangement, the filter end arrangement being one of a filter head or filter cover; the filter assembly including a filter cartridge removably mounted in a housing; the filter cartridge having an axially mounted seal member; the filter end arrangement having a plurality of end arrangement projections positioned to engage the filter cartridge can include the steps of positioning the filter cartridge such that the seal member is at least partially received within the end arrangement projections, allowing the filter cartridge to move axially toward the end arrangement; after the filter cartridge moves axially toward the end arrangement, engaging a thread on the housing with a thread on the end arrangement; and rotating the housing relative to the end arrangement to threadably connect the filter assembly to the filter end arrangement such that the end arrangement projections radially support a side of the filter cartridge seal member. In some examples, the arrangement includes a plurality of end arrangement receivers and the filter cartridge includes a plurality of filter cartridge projections, wherein the step of positioning the filter cartridge includes positioning the filter cartridge such that the plurality of filter cartridge projections are received by the end arrangement receivers.

A variety of examples of desirable product features or methods are set forth in part in the description that follows, and in part will be apparent from the description, or may be learned by practicing various aspects of this disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a cross-sectional view of a filter assembly according to one embodiment of the present disclosure, including a filter cartridge operably mounted within a filter bowl and connected to a filter head, the cross-section being taken along the line A-A of FIG. 2.

FIG. 1A is an enlarged, cross-sectional view of a portion of the filter cartridge depicted in FIG. 1.

FIG. 2 is a top, plan view of the filter assembly of FIG. 1.

FIG. 3 is a cross-sectional view of the filter assembly of FIG. 1, but without the filter cartridge mounted within.

FIG. 4 is an enlarged view of a section of the filter assembly from FIG. 3.

FIG. 5 is a perspective view of an embodiment of a liquid filter assembly, constructed in accordance with principles of this disclosure.

FIG. 6 is a cross-sectional view of the assembly of FIG. 5.

FIG. 7 is a perspective view of a filter cartridge used in the assembly of FIG. 6.

FIG. 8 is a cross-sectional view of the filter cartridge of FIG. 7.

FIG. 9 is an enlarged portion of the filter cartridge of FIG. 8.

FIG. 9A is a perspective, cross-sectional view of an alternative embodiment of the filter cartridge with the ramp surface as a separate piece from the rest of the cartridge end cap.

FIG. 10 is an enlarged perspective view of a top portion of the filter cartridge of FIG. 7.

FIG. 11 is an enlarged perspective view of a portion of FIG. 10.

FIG. 12 is a schematic diagram of the filter assembly of FIG. 5.

FIG. 13 is perspective view of a housing for the liquid filter assembly of FIG. 5.

FIG. 14 is a cross-sectional view of the housing of FIG. 13.

FIG. 14A is an enlarged view of a portion of FIG. 14.

FIG. 15 is a top perspective view of a cover used in the filter assembly of FIG. 1.

FIG. 16 is cross-sectional view of the cover of FIG. 15.

FIG. 17 is a cross-sectional view of one step of the cover of FIG. 15 being oriented onto the filter cartridge of FIG. 7.

FIG. 18 is an enlarged perspective view of a portion of the cover of FIG. 15.

FIG. 19 is an enlarged perspective view of a portion of FIG. 18.

FIG. 20 is a schematic cross-sectional view of an alternative embodiment of engagement between the filter cover and the filter element.

FIG. 21 is a schematic cross-sectional view of the embodiment of FIG. 20 in another step of engagement.

FIG. 22 is a schematic cross-sectional view of a portion of the filter assembly of FIG. 5, but without the filter element installed therewithin.

FIG. 23 is a top, plan cross-sectional view of the assembly of FIG. 22.

FIG. 24 a schematic cross-sectional view of the filter assembly of FIG. 22 and with the filter element operably positioned therein, during a step of assembly.

FIG. 25 is a schematic cross-sectional view of the filter assembly of FIG. 24, during another step of assembly.

FIG. 26 is a top, plan cross-sectional view of the filter assembly of FIG. 25.

FIG. 27 a schematic cross-sectional view of the filter assembly of FIGS. 25 and 26, showing full assembly.

FIG. 28 is a top, plan cross-sectional view of the filter assembly of FIG. 27.

FIG. 29 is a schematic cross-sectional view of an alternative embodiment of a filter assembly, during one step of assembly.

FIG. 30 is a top cross-sectional view of the filter assembly of FIG. 29.

FIG. 31 is a schematic cross-sectional view of the embodiment of FIG. 29, during another step of assembly.

FIG. 32 is a top cross-sectional view of the filter assembly of FIG. 31.

FIG. 33 a schematic cross-sectional view of the embodiment of FIG. 29 showing the filter assembly without a filter element operably installed therein.

FIG. 34 is a perspective view of another embodiment of a filter assembly according to the present disclosure, including a filter cartridge operably mounted (fully assembled) within a filter bowl and connected to a filter head.

FIG. 35 is a front elevational view of a portion of the filter assembly of FIG. 34, during one step of connecting the filter cartridge and bowl to the filter head.

FIG. 36 is a perspective view of the filter assembly portion of FIG. 35.

FIG. 37 is a perspective view of the filter assembly portion of FIG. 36 fully assembled.

FIG. 38 is a perspective view of the filter cartridge used in the filter assembly of FIGS. 34-17.

FIG. 39 is a perspective view of the filter head used in the filter assembly of FIGS. 34-17.

FIG. 40 is a perspective view of another embodiment of a filter assembly according to the present disclosure, including a tank having a filter head and removable cover, a filter cartridge (not visible) being operably mounted within the tank and connected to the filter head and cover.

FIG. 41 is a perspective, cross-sectional view of the filter assembly of FIG. 40, showing the filter cartridge operably mounted within the tank and connected to the filter head and cover.

FIG. 42 is an enlarged view of a portion of the filter assembly of FIG. 41.

FIG. 43 is a perspective view of portions of the filter cartridge and filter cover of FIG. 40 during one step of assembly.

FIG. 44 is a schematic depiction of an embodiment of the filter assembly during one step of connecting the assembly to a filter head or cover.

FIG. 45 is a schematic depiction of another embodiment of the filter assembly during one step of connecting the assembly to a filter head or cover; and

FIG. 46 is a schematic depiction of another embodiment of the filter assembly during one step of connecting the assembly to a filter head or cover.

FIGS. 47 to 50 show a partial view of an alternatively configured displacement arrangement and extensions usable with any of the filter assemblies disclosed herein.

FIGS. 51 to 52 are flat schematics illustrating geometric aspects of the projection-receiver arrangements for the filter assemblies disclosed herein.

FIGS. 53 and 54 are plan view schematics illustrating further geometric aspects of the projection-receiver arrangements for the filter assemblies disclosed herein.

FIGS. 55 to 66 are flat schematics of projection-receiver arrangements usable for any of the filter assemblies disclosed herein.

### DETAILED DESCRIPTION

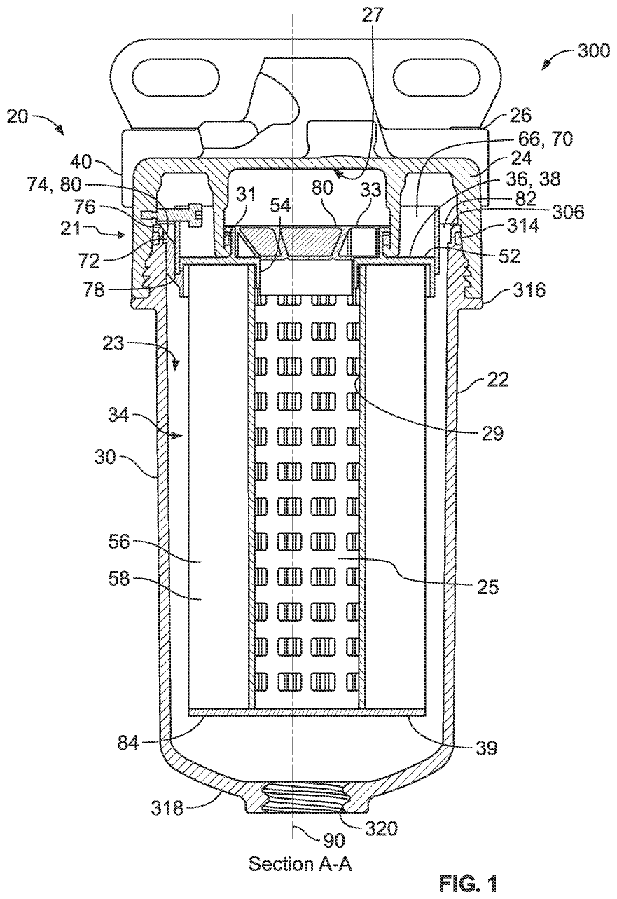

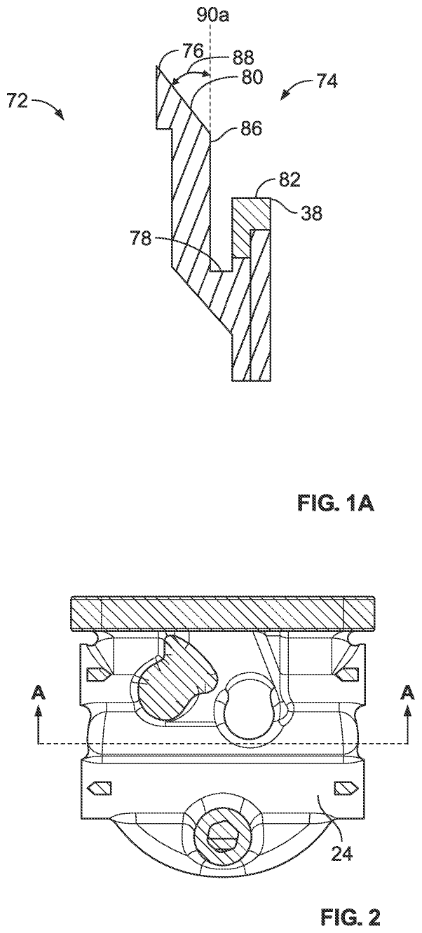

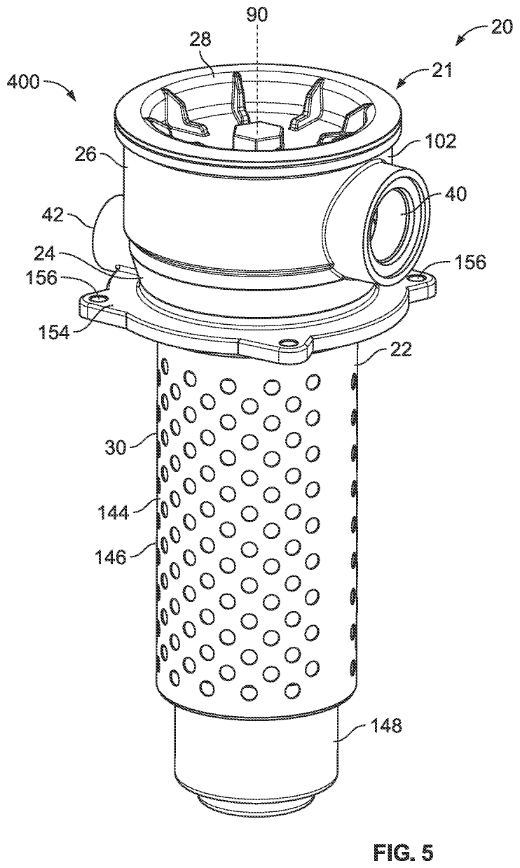

### Overview of Example Filter Assemblies, FIGS. 1 and 5

Two different liquid filter arrangement or assemblies 20 are shown in FIGS. 1 and 5. Although these assemblies 20 are differently constructed and used in different filtering systems (as will be further explained), common reference numerals are used for common parts.

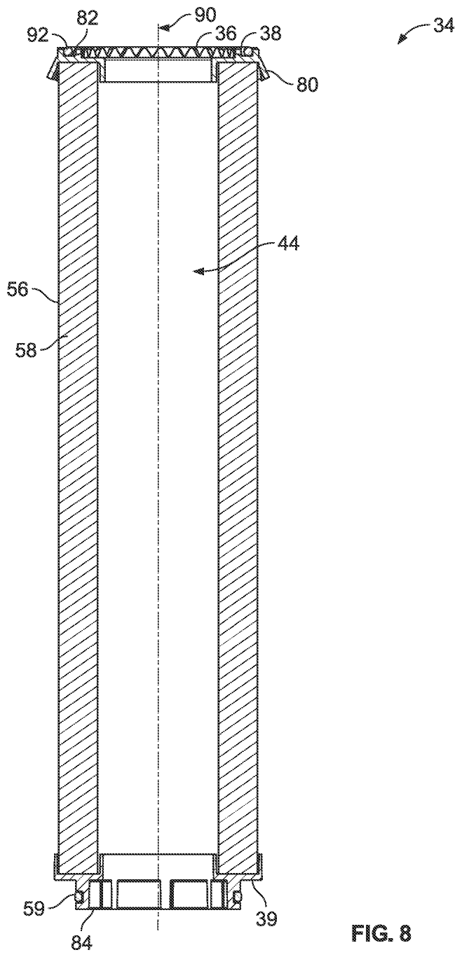

The liquid filter assembly 20 includes, operably positioned therein, a serviceable (i.e., removable and replaceable) filter element or cartridge 34 (FIGS. 1 and 6-10). The filter element or cartridge 34 has a first end 82 and opposite second end 84.

An end arrangement 21 is removably positionable over the filter element 34. As used herein, the “end arrangement 21” can include either a filter head 24 or a top or cover 28. In the assembly 20 of FIG. 5, the filter head 24 includes cover 28, removably positioned thereon; while in the assembly 20 of FIG. 1, the filter head 24 does not have a removable cover. For a typical liquid filter assembly, filter head 24 will be a cast member, for example, made from cast aluminum or other material. In the assembly 20 of FIG. 5, the cover 28 is secured to the filter head 24 with a threaded connection 48, to close a service aperture, with a seal member 50.

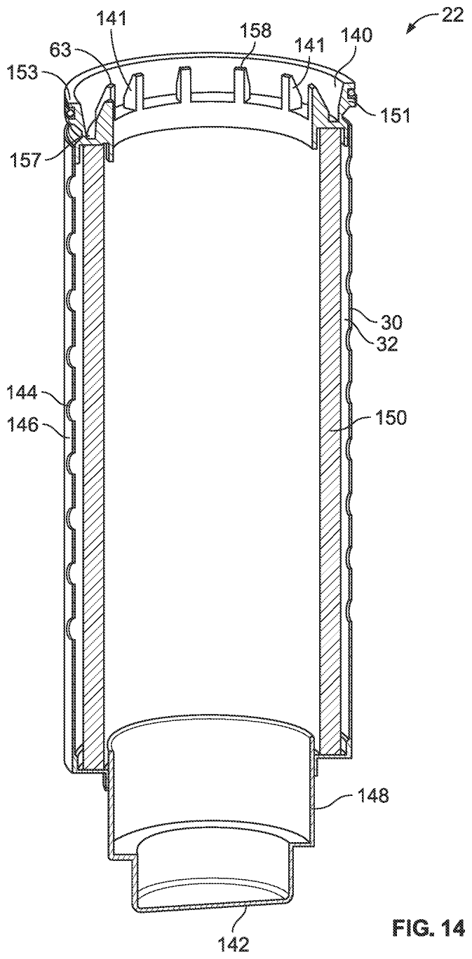

The assembly 20 can further include a housing 22 having a sidewall 30. In use, the sidewall 30 extends (depends downwardly) from filter head 24. In general, the housing 22 defines an internal volume 32 (FIGS. 4 and 14), in which selected internal componentry, as defined, is contained and certain filtering and flow operations occur.

Herein, “top,” “above,” and, “below,” are meant to refer to the assembly 20, when oriented for normal use, i.e., when in the orientation of FIGS. 1 and 5. The terms, by themselves, are not otherwise meant to be limiting or to have further definition.

The typical serviceable filter cartridge 34 further includes, as described below, an end cap arrangement 36 at the first end 82, which can be embodied as an upper or first end cap 38, which provides for a preferred mounting and sealing of the serviceable filter cartridge 34 to the filter head 24 within the liquid filter assembly 20. The second end 84 of the filter cartridge 34 includes a second end cap 39.

In general the serviceable filter cartridge 34 includes the first (upper in use) end cap 38. The first end cap 38, for the particular embodiment depicted, is mounted on an end (in use upper end) of the filter cartridge 34. The first end cap 38 includes an end cap portion 52 which, for example, can be a molded member secured (i.e., potted) to the filter cartridge 34. The end cap portion 52 includes a central aperture 54 for passage therethrough of liquid to be directed either to or from the end arrangement 21.

The end cap 38 can be molded from a variety of moldable plastic materials, for example, a polyamide (PA). As an example, a glass filled polyamide (15-30% glass filled by wt.) is usable. It can also be formed as a metal piece.

The filter cartridge 34 includes filter media 56, sometimes referred to herein as “media pack 56.” The media 56 can be a pleated media 58 contained within a pleated mesh or similar structure, with pleats extending between the opposite first end cap 38 and second end cap 39.

The media pack 56, as shown in the example embodiments, is generally tubular and surrounds an open volume. The tubular media pack 56 is depicted as cylindrical in shape. A central longitudinal axis 90 is centered within the media pack 56 and passes through the first end 82 of the element 34 and second end 84 of the element.

Typical operation of the assembly 20 of FIG. 1 is generally as follows: The filter head 24 includes a fluid inlet channel 40, which receives dirty fluid (e.g., oil) from an upstream source. The fluid to be filtered flows into the filter head 24 and then into an unfiltered liquid volume 23, which is the volume between the sidewall 30 and the filter media 56. From there, the fluid passes through the filter media 56 (referred to herein as a “filtering flow”), which removes dirt and debris from the fluid. The fluid enters a filtered liquid volume 25, which is within the interior of the media pack 56. From there, the filtered liquid flows through the aperture 54 in the first end cap 38 and into the filter head 24. It exits the filter head 24 through an outlet channel 27. The foregoing describes a “forward flow” operation (outside to in). In some cases, the assembly 20 can also operate in a “reverse flow” operation, in which the flow is inside to out.

Typical operation of the assembly 20 of FIG. 5 is generally in accord with the following. The filter head 24 generally includes a body 26 having fluid channels 40, 42. The fluid channel 40 can typically be an inlet 40 or inlet arrangement. The fluid channel 42 can be a bypass channel. Liquid to be filtered is directed into inlet arrangement 40. The unfiltered liquid then flows into an unfiltered liquid volume 44, in the interior of the filter cartridge 34. In general, volume 44 is an “unfiltered liquid volume,” since the liquid received therein will generally be received directly from a circulation loop, and will be unfiltered and require filtering. In normal operation, from the unfiltered liquid volume 44, the liquid is passed through the filter cartridge 34 to a filtered volume 46 surrounding the filter cartridge 34 (a filtering flow). From the filtered volume 46, the liquid can pass out of the filter cartridge 34 to the tank in which the cartridge 34 is sitting in. Although alternatives are possible, it is noted that the assembly of FIG. 5 does not include a central standpipe projecting into the cartridge 34.

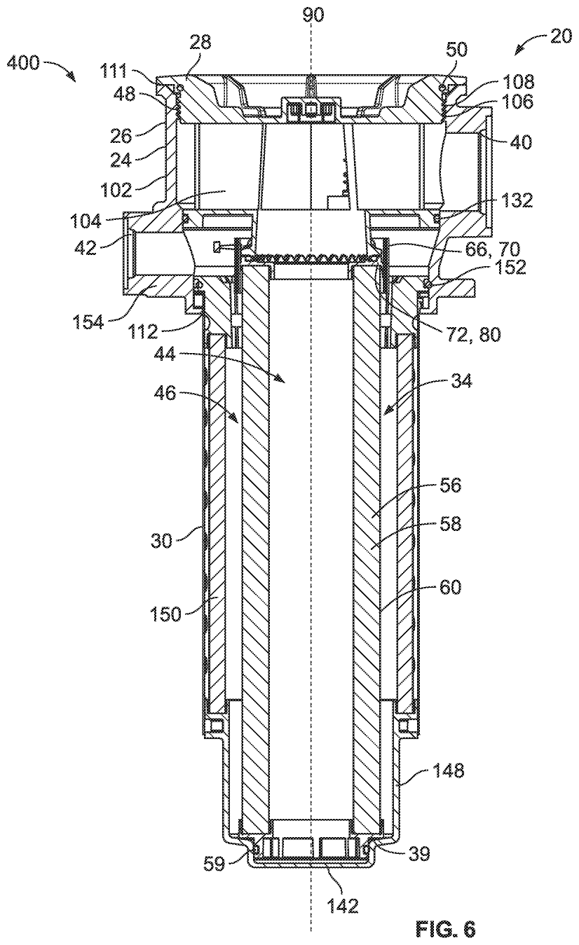

The second end cap 39 in FIG. 1 is closed. In general, the second end cap 39 can either be closed or open. In FIG. 6, a seal member 59 is against an outer radial surface of the second end cap 39 and forms an outwardly directed radial seal with the sidewall 30 of the housing 22.

In some assemblies. it may be desirable to provide the filter cartridge 34 with a downstream outer liner 60 (FIG. 6) such as a porous metal or plastic liner. For the forward flow assembly of FIG. 1, the downstream liner 29 is an inner liner 29 that surrounds the filtered liquid volume 25 in the interior of the media pack 56.

In FIG. 1, the filter element 34 includes a seal member 31. The seal member 31 is radially directed to form a seal with a portion of the filter head 24. In the example shown, the seal member 31 is held by a seal holder projection 33 extending axially from the first end cap 38 in a direction away from the filter media pack 56 and toward the filter head 24. The seal member 31 forms a seal between the unfiltered liquid volume 23 and the filtered liquid volume 25. The seal member 31 is positioned radially between a radial position of upstream and downstream tips of the pleated media 58.

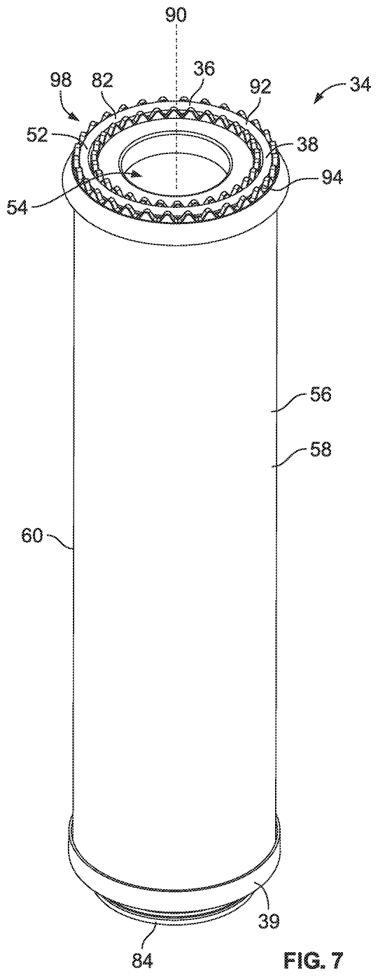

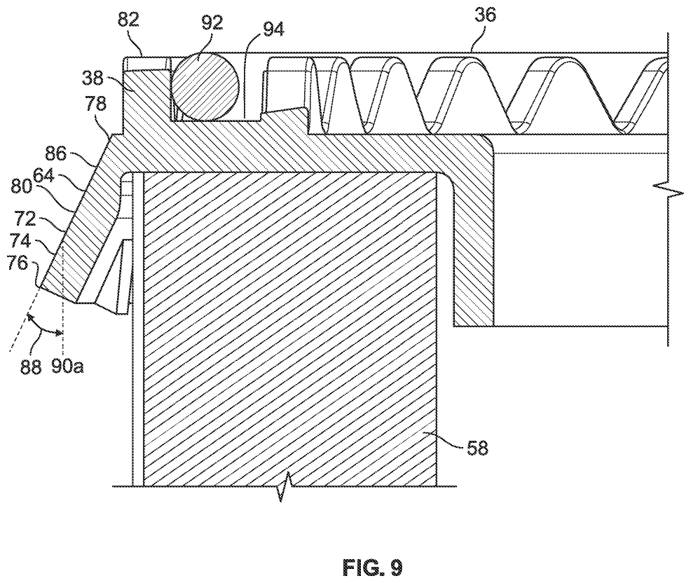

In FIG. 7, the filter clement 34 includes a seal member 92 secured to an axial portion 94 of the end cap arrangement 36 within a plane orthogonal to the central longitudinal axis 90. In the example embodiment shown, the seal member 92 is oriented on the axial portion 94 of the first end cap 38. As shown at FIG. 9, the axial portion 94 supporting the seal member 92 is disposed orthogonally to the longitudinal axis of the filter cartridge. However, the axial portion 94 may be provided with a frusto-conical shape that is either canted at an angle toward or away from the longitudinal axis such that the axial portion is disposed at an oblique angle to the longitudinal axis.

In some embodiments, and as shown in FIGS. 7, 10, and 11, there can be an optional anti-rotation arrangement 98. The anti-rotation arrangement 98 is provided to minimize or prevent the seal member 92 from bunching when the filter element 34 is secured to a filter cover 28. The anti-rotation arrangement 98 is described further below.

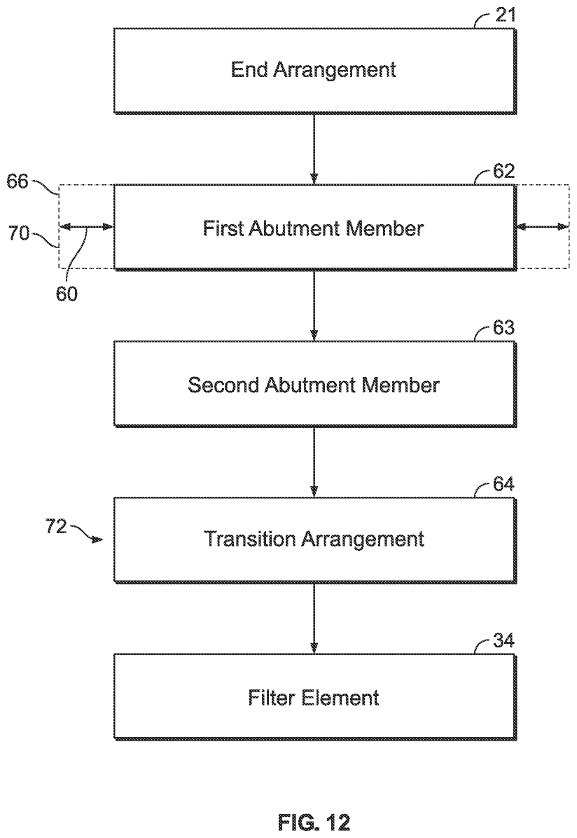

### Overview of Method of Installation, FIG. 12

FIG. 12 is a schematic diagram providing an overview of a method of installation of the filter cartridge 34 into the housing 22, for each of the FIG. 1 and FIG. 5 assemblies.

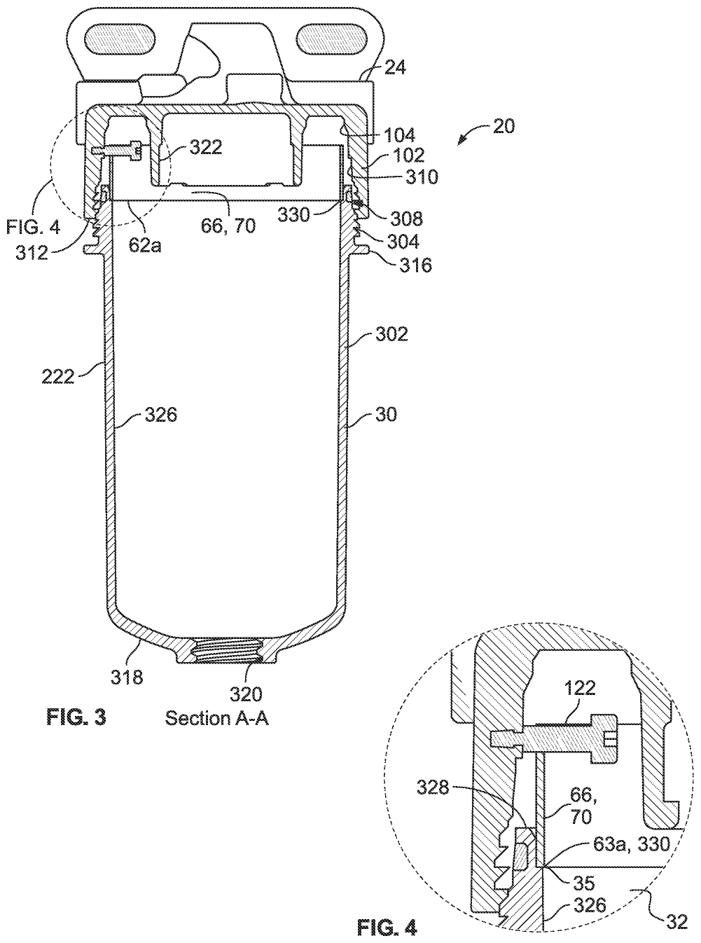

The assembly 20 includes a first abutment member 62 and a second abutment member 63 The first abutment member 62 and second abutment member 63 are capable of abutting at their respective engagement surfaces/regions 62a, 63a (FIGS. 3, 4, 16, 22) when the assembly 20 is in a first condition and prevented from abutting when the assembly 20 is in a second condition.

The assembly 20 further includes a transition arrangement 64. The transition arrangement 64 enables transition of the assembly 20 between the first condition and second condition.

In general, the first condition prevents the end arrangement 21 from fully connecting to a remaining portion of the assembly 20, such as filter head 24 or the housing 22. The second condition allows full connection between the end arrangement 21 and the remaining portion of the assembly. By “fully connecting”, it is meant that, if there is a threaded engagement, enough of the threads are secured to ensure that all of the seal members are in place to form seals in the intended locations.

While many embodiments are possible, the first abutment member 62 includes a radially flexible member 66. In FIG. 12, the radially flexible member is shown in phantom lines as moving radially along the arrow 68. In preferred implementations, the first abutment member 62 is axially rigid. By “axially rigid,” it is meant that along a direction perpendicular to a plane that contains the direction of radial flexibility, the first abutment member 62 is rigid and does not move under normal compressive or tensile force. By “normal” compressive or tensile force, it is meant forces that are not so extreme that they damage or break the first abutment member 62.

The first condition includes the radially flexible member 66 having a first outermost dimension, and the second condition includes the radially flexible member 66 having a second outermost dimension. In some examples, the first outermost dimension is smaller than the second outermost dimension. In other examples, the first outermost dimension is larger than the second outermost dimension.

In some implementations, the radially flexible member 66 includes a radially flexible and axially rigid spring 70. There can be many embodiments including a spiral spring, or a flat spring, or a clock spring, or a flat spring curved to form only a partial (incomplete) loop, or a tension coil.

In some example embodiments, at rest (not under force), the radially flexible and axially rigid spring 70 is at its first, smaller outermost dimension. In other embodiments, the radially flexible and axially rigid spring 70, at rest (not under force), is at its second, larger outermost dimension.

The radially flexible member 66 is an integral part of the assembly 20. In the example embodiments shown, the radially flexible member 66 is connected to the end arrangement 21, which can include the filter head 24 or the cover 28. It is foreseen that the radially flexible member 66 could be connected to other parts of the assembly 20 as well.

The transition arrangement 64 is mechanically associated with the filter element 34. For example, the transition arrangement 64 includes a displacement arrangement or member 72 secured to the media pack 56. In some embodiments, the transition arrangement 64 can also be a separate part independent of the filter element 34.

An example embodiment of the displacement arrangement 72 is shown in FIGS. 1A and 9. The displacement arrangement 72 includes an engagement projection 74 having a leading edge 76 and a trailing edge 78. In the example of FIG. 1A, the trailing edge 78 is closer to the central longitudinal axis 90 (FIG. 1) than the leading edge 76. In the example of FIG. 9, the leading edge 76 is closer to the central longitudinal axis 90 than the trailing edge 78.

The engagement projection 74 can be either a radially continuous surface or radially dis-continuous surface. In the example shown in FIG. 1A, the engagement projection 74 is radially continuous. The engagement projection 74 can also include at least one gap, and in some cases, a plurality of gaps. In the example of FIG. 9, the engagement projection 74 is continuous and is without any interruptions along the circumference.

The engagement projection 74 can be straight or other shapes (curved, irregular, etc.). In the example of FIG. 9, the engagement projection 74 is shown as straight and forms a ramp 80 (or ramp arrangement 80) on the filter element 34. The ramp 80 projects radially from the first end 82 of the filter element 34. In the example of FIG. 1, the engagement projection 74 is straight and forms a straight ramp arrangement 80 on the filter element 34. In some examples, the engagement projection 74 is non-straight and forms a curved ramp arrangement 80 on the filter element 34. In FIG. 1, the ramp arrangement 80 projects radially from the first end 82 of the filter element, and the leading edge 76 projects over or above an end surface of the first end cap 38.

In FIG. 1, the radially flexible member 66 slides against the ramp arrangement 80 to move the radially flexible member 66 to a radially inward position. When the radially flexible member 66 is a spring 70 and arranged as shown in FIG. 1, the spring 70 moves radially inwardly when engaged against the ramp arrangement 80, and the spring 70 returns to its rest position to move back radially outwardly (FIG. 4) when free of contact with the ramp arrangement 80.

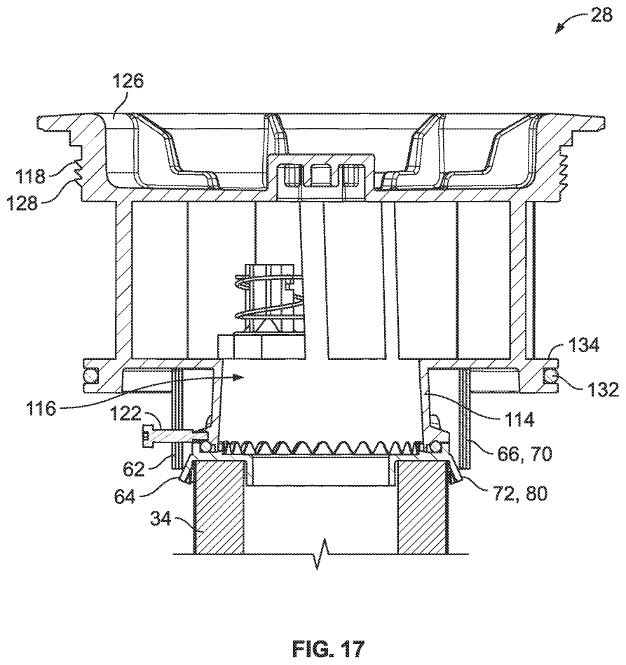

In FIGS. 6 and 17, the radially flexible member 66 slides against the ramp 80 to move the radially flexible member 66 to a radially outwardly position. When the radially flexible member 66 is a spring 70 and arranged as shown in FIGS. 6 and 17, the spring 70 moves radially outwardly when engaged against the ramp 80, and the spring 70 returns to its rest position to move back radially inwardly when free of contact with the ramp 80.

The ramp 80 has a ramp surface 86 angled as measured along a surface between end points at a non-zero and non-perpendicular angle 88 (FIGS. 1A and FIG. 9) relative to the longitudinal axis 90 and relative to a line 90a parallel to the longitudinal axis 90. In FIG. 1A, the ramp surface 86 is angled no less than 5 degrees, to ensure that the spring 70 is radially displaced inwardly far enough to ensure that the filter head 24 can move into engagement with the housing 22. The ramp surface 86 is angled no more than 80 degrees to ensure that the spring 70 is radially displaced at all. Typically, the ramp surface 86 is angled at angle 88 between 5 to 80 degrees. In many cases, the angle 88 will be 15 to 75 degrees. Preferably, the angle 88 is between 30 to 40 degrees.

In FIG. 9, the ramp surface 86 is angled at an angle 88 of at least 5 degrees, to ensure that the spring 70 is radially displaced far enough to ensure that the cover 28 can move into engagement with the housing 22. The ramp surface 86 is angled at an angle 88 of not greater than 80 degrees to ensure that the spring 70 is radially displaced at all. In preferred arrangements, the ramp surface 86 is angled at an angle 88 of between 5 to 80 degrees; preferably about 15 to 70 degrees, and typically about 20 to 30 degrees.

In preferred arrangements, the ramp surface 86 is an integral part of the first end cap arrangement 36. As shown in FIGS. 1 and 9, the ramp surface 86 is part of the first end cap 38. As such, if the first end cap 38 is molded, the ramp surface 86 can be a molded part with the rest of the first end cap 38. In FIG. 9A, the ramp surface 86 is a separate piece 86a from the rest of an end cap 38a. This separate piece 86a can be fitted or snapped over the end cap 38a.

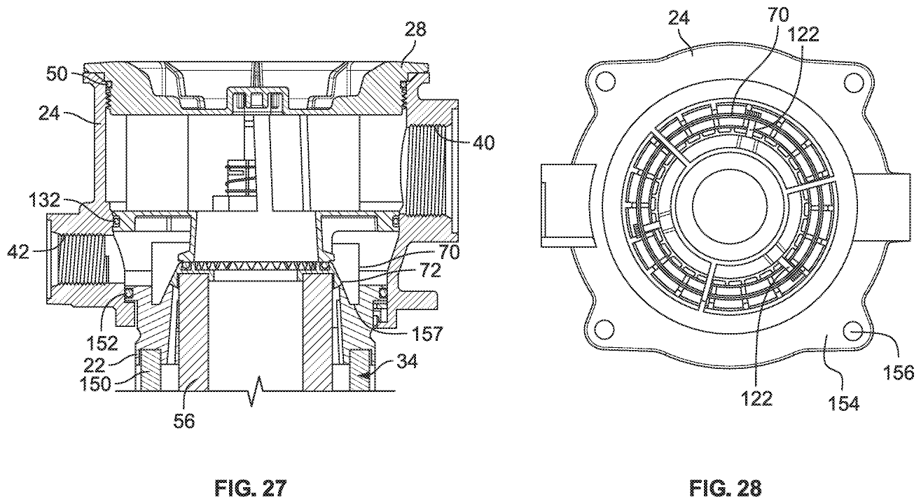

FIGS. 1 and 5 show the filter assembly 20 with the filter element 34 correctly positioned within housing 22, and with the end arrangement 21 mounted on and connected (threaded) to the remaining part of the assembly. FIGS. 17 and 25-28 show steps of mounting the cover 28 onto the filter element 34. In FIGS. 17 and 25-28, the radially flexible and axially rigid spring 70 engages against the ramp surface 86 and is displaced radially outwardly from the smaller dimension to the larger dimension. This radial displacement of the radially flexible and axially rigid spring 70 allows the cover 28 to move axially toward the element 34 and deeper into the filter head 24 (FIGS. 6 and 27), which then allows the threaded connection 48 between the head 24 and cover 28 to engage. In FIG. 1, the radially flexible and axially rigid spring 70 engages against the ramp surface 86 and is displaced radially inwardly from the larger dimension to the smaller dimension. This radial displacement of the radially flexible and axially rigid spring 70 allows the filter head 24 to move axially toward the housing 22, which then allows the threaded connection 48 between the head 24 and housing 22 to engage.

If the filter element 34 did not include the properly shaped ramp surface 86, or if an element is absent from the assembly 20, the radially flexible and axially rigid spring 70 would not radially displace, and the radially flexible and axially rigid spring 70 would abut against the second abutment member 63. This abutment would prevent the end arrangement 21 from moving deeper and into threaded connection 48.

For example, in FIGS. 3 and 4, the radially flexible and axially rigid spring 70 abuts an inwardly projecting shelf or ledge 35 extending radially inwardly from the sidewall 30 of the housing 22, preventing the filter head 24 from moving deeper toward the housing 22 and blocking threaded engagement 48 between the filter head 24 and housing 22. This is explained in more detail below, in connection with the description of FIGS. 1-4.

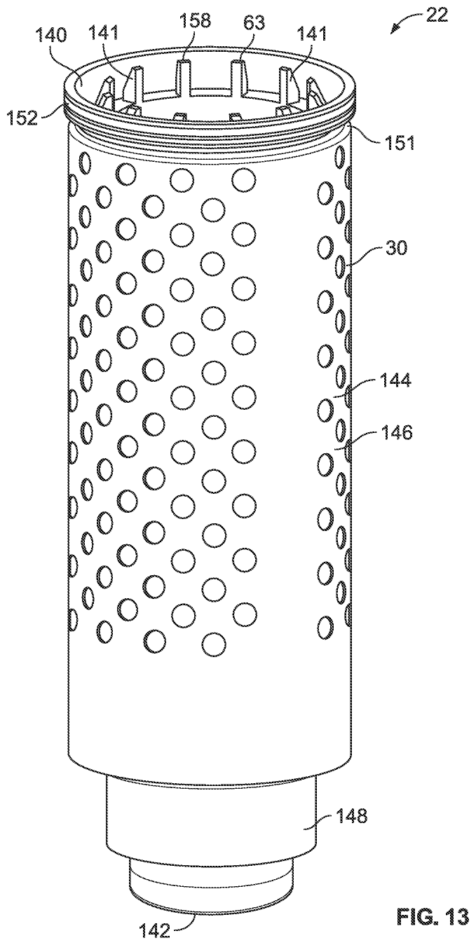

In the example shown in FIGS. 13, 14, 14A, and 22, the radially flexible and axially rigid spring 70 abuts an extension 141 extending axially from an end construction 151 on the housing 22, preventing the filter head 24 from moving deeper toward the housing 22 and blocking threaded engagement 48 between the filter head 24 and housing 22. This is explained in more detail below, in connection with the description of the in-tank filter assembly of FIGS. 5, 6, and 15-17.

### Example Bowl-Cartridge Arrangement, FIGS. 1-4

The assembly 20 in FIGS. 1-4 is a bowl-cartridge arrangement 300. In the bowl-cartridge arrangement 300, the filter cartridge (or filter element) 34 is removable and replaceable within the housing 22. The housing 22 is a bowl 302 that is selectively attachable and detachable from the filter head 24. In this example, the bowl 302 has threads 304 (FIG. 3) along an outer surface of the sidewall 30 and adjacent an open mouth 306 (FIG. 1). The threads 304 then threadably connect to threads 308 (FIG. 3) on the filter head 24.

Although the example shown is a bowl-cartridge arrangement 300, in alternatives, it could also be a spin-on assembly, in which the element is permanently part of and non-removable from the housing. Rather, the combination of the housing and element are one unit that is spun on by threads onto the filter head. For servicing, the entire housing and element are disposed of and replaced onto the filter head.

Referring again to FIGS. 1 to 3, at an end 318 of the bowl 302 opposite of the mouth 306, the bowl 302 has an open aperture 320. The open aperture 320 can accommodate a drain valve or other structure.

The filter head 24 has an outer wall 102 surrounding an open interior 104. Along an inner surface 310 of the wall 102 are the threads 308 of the filter head 24. The filter head 24 has a bowl-receiving opening 312 defined by the wall 102, which is sized to receive the bowl 302 for threaded engagement.

The bowl 302 holds a seal member 314 to form a releasable seal with the filter head 24. In this example, the seal member 314 is radially directed in an outward direction, away from the longitudinal axis 90. The seal member 314 is adjacent to a terminal end of the sidewall 30 of the housing 22.

Below the threads 304 on the bowl 302 is a radially projecting stop flange 316. The flange 316 provides a stop surface or abutting surface to receive a terminal end of the filter head 24. The threads 304 are located axially between the stop flange 316 and the seal member 314.

The filter head 24 includes an internal wall 322 (FIG. 3). The seal member 31 from the filter element 34 forms a releasable seal with the wall 322. In the example shown, the seal member 31 is radially directed in an outward direction to form the seal along a radially inward surface of the wall 322. In other embodiments, the seal member 31 could be radially directed in a radially inward direction against an outer portion of the wall 322.

Along the inner surface of the sidewall 30 of the bowl 302 and adjacent to the mouth 306 is the inwardly extending shelf or ledge 35. The ledge 35 comprises the second abutment member 63 and provides an engagement region/surface 63a to receive the first abutment member 62. In the example shown in FIG. 4, the ledge 35 is part of the inner wall 322 of the bowl 302, and it is recessed inwardly from a remaining part of the inner wall 322 at the region extending from a terminal end 328 of the bowl 302 to a point 330 (FIG. 3) spaced from the terminal end 328. The point 330 is typically a distance less than 10% of an overall length of the sidewall 30 from the terminal end 328.

The first abutment member 62, shown as radially flexible and axially rigid spring 70, is depicted in FIGS. 1-4 as attached to the filter head 24. In this example, the radially flexible and axially rigid spring 70 has apertures that accommodate two or more posts 122 (FIG. 4) projecting radially inwardly from the wall 102 of the filter head 24. As such, the radially flexible and axially rigid spring 70 is slidably mounted on the plurality of posts 122. The posts are shown as including a head to aid in retention of the spring 70, but can also be provided without heads in some arrangements and configurations. The radially flexible and axially rigid spring 70 is circumscribed by the wall 102, and itself is radially spaced from and circumscribes the inner wall 322 of the filter head 24. The radially flexible and axially rigid spring 70 has an engagement region/surface 62a, which is the terminal end of the spring 70, and it engages or abuts the ledge 35 (FIGS. 3 and 4) at engagement surface 63a, when there is attempted connection between the filter head 24 and bowl 302, but there is no filter element-or the improper filter element-installed in the bowl 302. This engagement of the spring 70 with the ledge 35 prevents the threads 308 on the filter head 24 from connecting with the threads 304 on the filter bowl 302.

When the proper filter element 34 is in the interior of the filter bowl 302, the displacement member 72 (FIG. 1A) engages the radially flexible and axially rigid spring 70 to move the radially flexible and axially rigid spring 70 radially inwardly. This allows the filter head 24 to move into threaded engagement and connection with the threads 304 and the filter bowl 302 and form the seal between seal member 31 and inner wall 322; and form the seal between seal member 314 (FIG. 1) and the filter head 24.

### Example In-Tank Filter Assembly; FIGS. 5, 6, 15-17

The assembly 20 in FIGS. 5 and 6 is an in-tank filter arrangement 400. In-tank filter arrangements 400 are used typically in hydraulic systems and are submerged within a tank of hydraulic oil to keep the oil clean and free from debris. In many typically arrangements, the in-tank filter arrangement 400 is used to filter fluid before it leaves the tank to enter an inlet line of a pump.

In reference now to FIGS. 5, 6, and 22-27, the in-tank filter arrangement 400 includes filter head 24. The filter head 24 has a wall 102 surrounding open interior 104 and fluid channels (e.g., 40, 42). The filter head 24 has a first fastener arrangement 106 along the wall 102. The first fastener arrangement 106 is shown as threads 108 forming part of the threaded connection 48. The wall 102 has opposite first and second ends 111, 112, each of the first and second ends 111, 112 being open.

The filter head 24 includes a flange 154 contained within a plane generally orthogonal to the longitudinal axis 90. The flange 154 has holes 156 (e.g. FIG. 23), which receive bolts to allow the filter head 24 to be secured to a fluid tank.

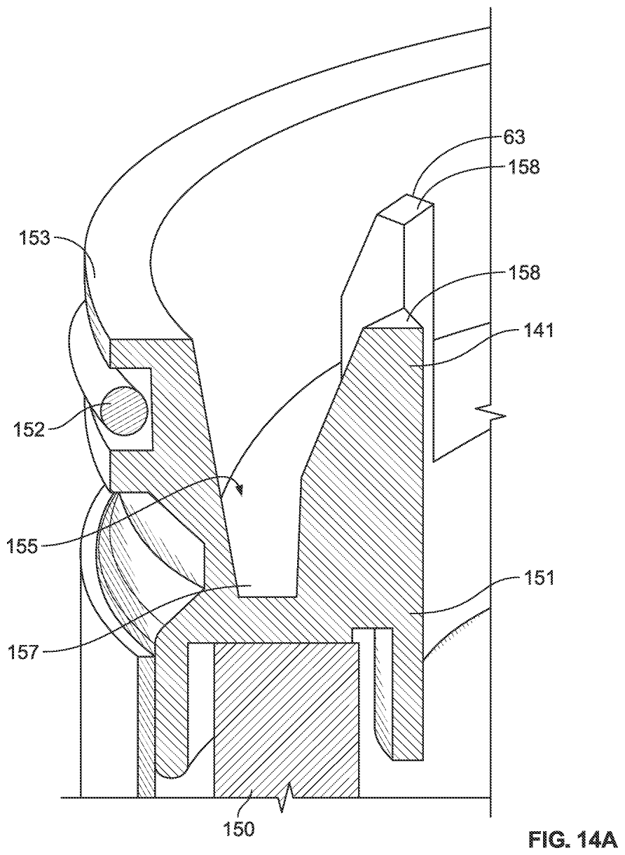

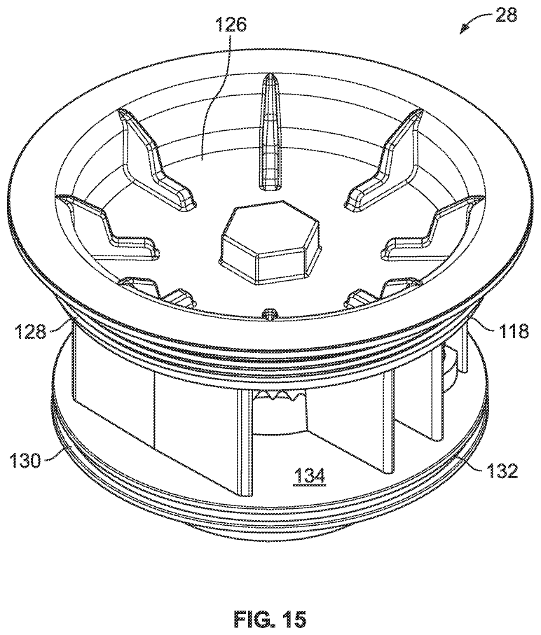

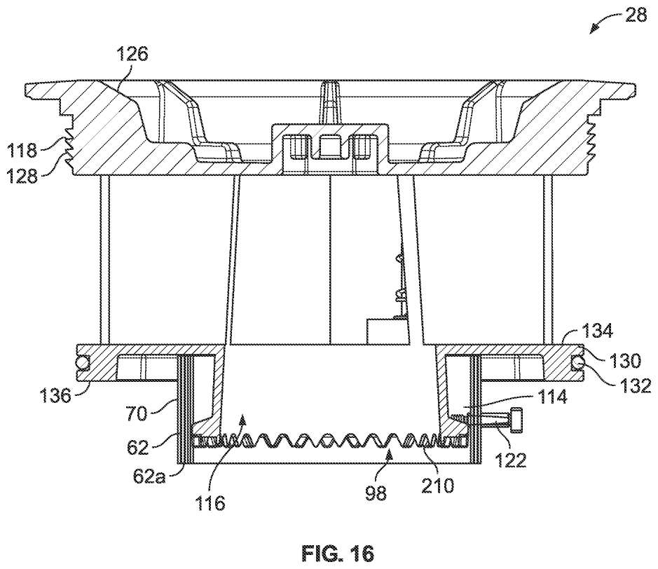

FIGS. 15 and 16 show an example embodiment of the cover 28. The cover 28 is sized to be removably positioned within the interior 104 of the filter head 24. The cover 28 includes a central hub 114 circumscribing a fluid conduit 116 in communication with the fluid channels 40, 42 of the filter head 24. A second fastener arrangement 118 is constructed and arranged for removable connection with the first fastener arrangement 106. The second fastener arrangement 118 includes threads 120 for mating with threads 108.

The first abutment member 62, shown as radially flexible and axially rigid spring 70, is depicted herein as attached to the cover 28. In this example, the radially flexible and axially rigid spring 70 has apertures that accommodate two or more posts 122 projecting radially from the hub 114. As such, the radially flexible and axially rigid spring 70 is slidably mounted on the plurality of posts 122. The radially flexible and axially rigid spring 70 circumscribes the central hub 114, and moves radially in response to force against the radially flexible and axially rigid spring 70 by the displacement member 72.

In reference now to FIG. 16, the cover 28 includes a closed cover member 126 having an outer radial surface 128 defining the second fastener arrangement 118. A sealing ring 130 is axially spaced from the cover member 126. The scaling ring 130 holds a radially oriented seal member 132 and is positioned to form a seal with the filter head 24.

The sealing ring 130 has a first axial surface 134 and an opposite second axial surface 136. The first axial surface 134 faces the cover member 126. The central hub 114 extends from the second axial surface 136.

In the example shown, the central hub 114 has an outer diameter that is 50 to 80% of an outer diameter of the sealing ring 130. As shown, the radially oriented seal member 132 of the scaling ring 130 is outwardly directed.

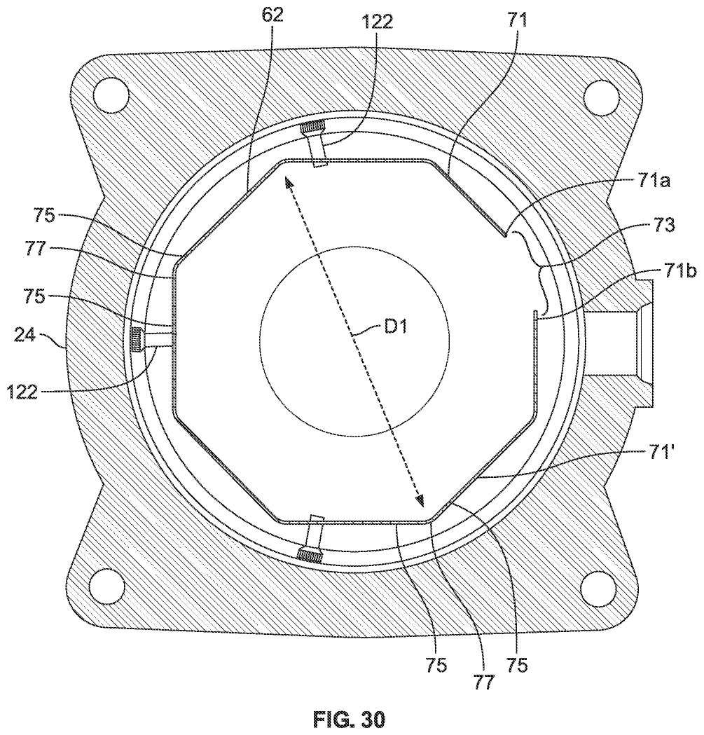

In example embodiments, the first abutment member 62 (e.g., the radially flexible and axially rigid spring 70 in one example) is radially movable between an innermost position to an outermost position; the innermost position has a dimension (when round, a diameter) D1. The outermost position has a dimension (when round, diameter) D2. A ratio of D1:D2 is between 0.74 and 0.98. An example of where D1 and D2 is measured is shown in FIGS. 30 and 32. In FIG. 30, D1 is the dimension that passes through the geometric center point and which is tangent to the innermost region of the radially flexible and axially rigid spring 70. In FIG. 32, D2 is the dimension that passes through the geometric center point and which is tangent to the outermost region of the radially flexible and axially rigid spring 70.

An example embodiment of the sidewall 30 of the housing 22 is shown in FIGS. 13 and 14. The sidewall 30 has an open mouth 140 and an opposite closed end 142. The open mouth 140 receives the filter element 34 therewithin.

The sidewall 30 is depicted as tubular, specifically cylindrical and extends between the mouth 140 and the closed end 142. The sidewall includes a first section 144, perforated, which operates as a strainer 146. Extending between the first section 144 and the closed end 142 is a second section 148. The second section 148 has a smaller diameter than the first section 144. The second section 148 is less than 50% of the length of the first section 144.

The first section 144 is shown holding an optional second stage of filter media 150. The filter media 150 can be pleated media, or other types of media. The second stage of filter media 150 is radially spaced from the media pack 56 of the element 34. In the example arrangement shown, the second stage of filter media 150 circumscribes the media pack 56 and has an overall length between 50 to 90% of the media pack 56. Many alternatives are possible.

At an end of the sidewall 30 is an end construction 151. The filter media 150 is secured to the end construction 151. The end construction 151 includes an outer axially projecting seal holder ring 153, extending along an outer perimeter of the end construction 151 and circumscribing the mouth 140. The seal holder ring 153 holds a seal member 152 around the external surface circumscribing the mouth 140. In the example shown, the seal member 152 is directed radially outwardly. The seal member 152 forms a seal with the filter head 24 (sec FIG. 6).

The end construction 151 further includes one or more extensions 141 projecting axially therefrom, away from the filter media 150 and along an inner perimeter of the end construction 151 and an inner diameter of the filter media 150. The extensions 141 are shorter in length than the seal holder ring 153. The seal holder ring 153 circumscribes the extensions 141 and are radially spaced therefrom to provide a receiving pocket 155 (FIG. 14A) therebetween. The end construction 151 has an engagement surface 157 at a closed end of the receiving pocket 155. The engagement surface 157 is along an external surface of the end construction 151 at an opposite side of the filter media 150. The engagement surface 157 provides a surface for the radially flexible and axially rigid spring 70 to engage against when the assembly is in the second condition-that is, in the FIG. 5 embodiment, after the spring 70 has flexed radially outwardly to allow the end arrangement 21 (such as the cover 28) to move downwardly to put seal members 132 and 50 in their intended positions to form seals with the filter head 24; and to allow threaded connection between the cover 28 and the filter head 24.

The extensions 141 can include at least one and in the embodiment shown, includes a plurality of circumferentially spaced extensions 141.

Each of the extensions 141 include a terminal end 158, which is the free end of the extensions 141 spaced away from the engagement surface 157 and the filter media 150. The terminal ends 158 are located to form the second abutment member 63 for engaging against the first abutment member 62, when the assembly 20 is in the first condition. The first condition prevents the end arrangement 21 (in this case the cover 28) from fully connecting to a remaining portion of the assembly 20 (in this case, the filter head 24).

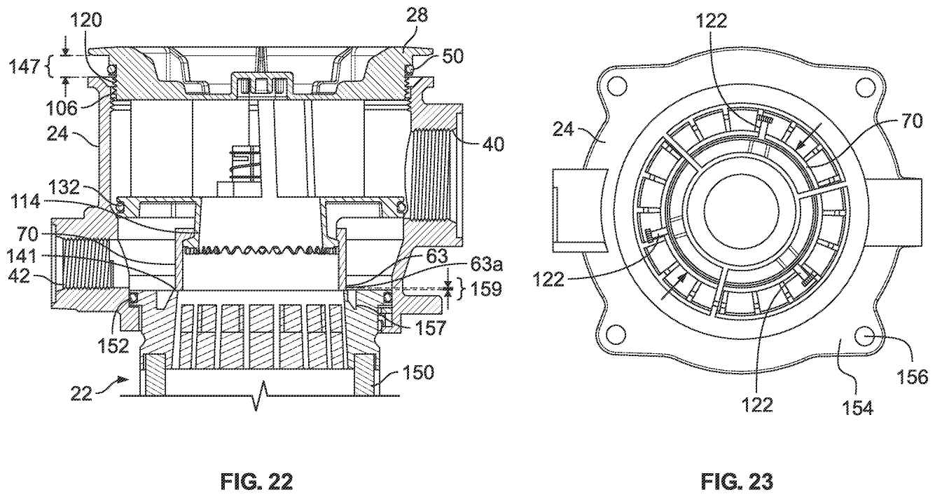

As shown in FIG. 22, when there is no filter cartridge 34 installed in the housing 22, there is no transition arrangement 64 to enable transition of the assembly 20 to the second condition. That is, there is no displacement arrangement 72 (FIG. 9) to radially flex the radially flexible and axially rigid spring 70, in this example, from a first (smaller) outermost dimension to a second (larger) outermost dimension. As such, an end of radially flexible and axially rigid spring 70 abuts (engages against) the terminal ends 158 of the extensions 141. The abutment is shown by arrows 159 in FIG. 22. When the radially flexible and axially rigid spring 70 abuts the terminal ends 158 of the extensions, the cover 28 is prevented from moving downwardly into the filter head 24; preventing threaded engagement between threads 120 on the cover 28 and threads 108 on the filter head 24, leaving a gap 147a therebetween. The seal members 50 and 132 are prevented from forming seals with the filter head 24. FIG. 23 is a top view, showing the radially flexible and axially rigid spring 70 in the first (smaller) outermost dimension.

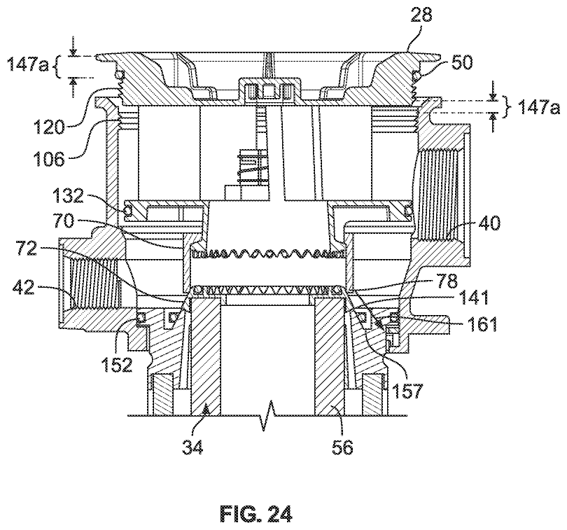

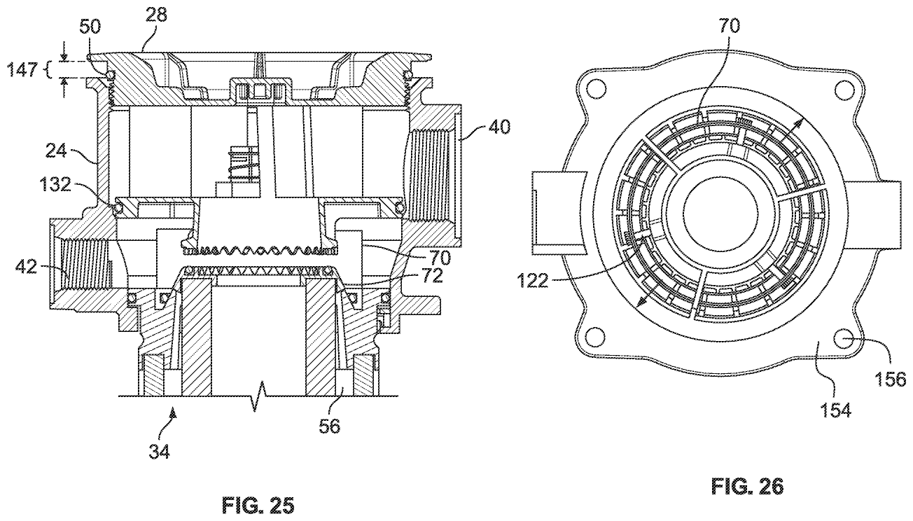

FIGS. 24 and 25 show steps of assembly of the filter assembly 20. The filter cartridge 34 is properly operably installed in the housing 22 with the seal member 150 forming a seal with the filter head 24. In FIG. 24, the cover 28 is initially being lowered into position in the filter head 24. There is engagement between the spring 70 and the trailing edge 78 of the displacement arrangement 72, which starts to move the spring radially outwardly (see arrow 161). The space between the cover 28 and head 24 is shown at gap 147b, which is too big for threaded engagement. In FIGS. 25 and 26, the spring 70 has flexed radially outwardly, as the cover 28 with the spring 70 has continued to move deeper into the filter head 24, making the gap 147b smaller, but still too big for threaded engagement. The spring 70 is moving into the receiving pocket 155 (FIG. 14A) in a direction toward the engagement surface 157.

FIGS. 27 and 28 show full assembly. The cover 28 and filter head 24 are connected together, and the seals at 50 and 132 are in place between the cover 28 and filter head 24. The radially flexible and axially rigid spring 70 is within the receiving pocket 155 and may be engaged against (or just next to) the engagement surface 157. FIG. 28 shows the radially flexible and axially rigid spring 70 at its second (larger) outermost dimension.

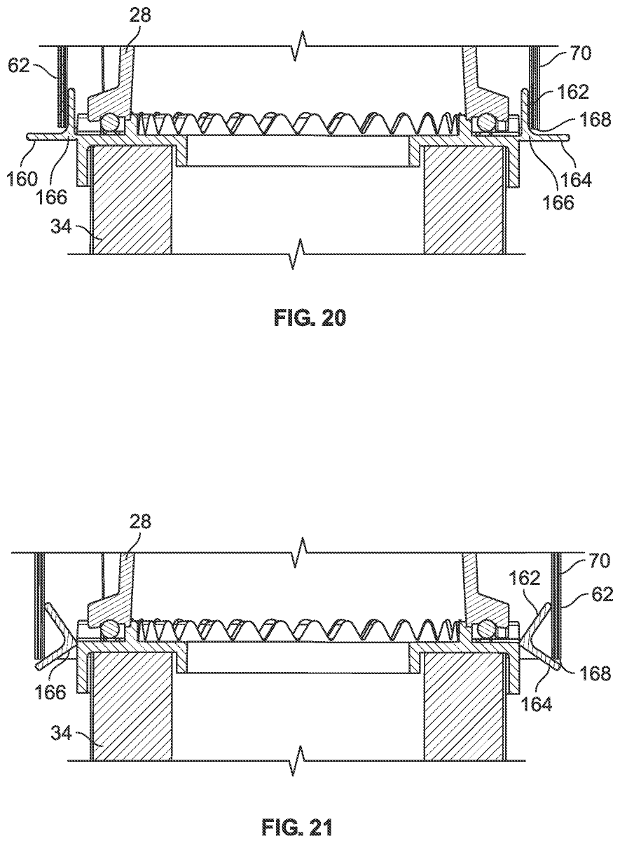

### Alternative Embodiment, FIGS. 20-21

FIGS. 20 and 21 show an alternative embodiment of the filter assembly 20. In this embodiment, the displacement member 72 includes a living hinge 160. The living hinge 160 is secured to the end cap arrangement 36. For example, the living hinge 160 can be an integrally molded part of the first end cap 38 along the outer radial circumference.

The living hinge 160 includes first and second legs 162, 164, oriented generally perpendicular to each other. A hinge pivot point 166 is at the intersection of 162, 164.

In FIG. 20, the first leg 162 is vertically oriented to be generally parallel to the longitudinal axis 90, while the second leg 164 is horizontally oriented.

When the cover 28 is being oriented over the filter element 34, the first abutment member 62 (e.g., radially flexible and axially rigid spring 70) passes over the first leg 162 (vertically oriented leg 162) to circumscribe the first leg 162. A terminal end 168 of the first abutment member 62 (e.g., radially flexible and axially rigid spring 70) abuts or engages against the second leg 164 (horizontally oriented leg 164).

In FIG. 21, as the first abutment member 62 (e.g., spring 70) makes contact with the horizontally oriented second leg 164, the vertically oriented first leg 162 rotates about a pivot point 166 radially outwardly, pushing the first abutment member 62 (e.g., spring 70) radially outwardly. The further down the second leg 164 gets pushed, the more the first leg 162 pushes the first abutment member 62 (e.g., spring 70) outward. This radial displacement of the spring 70 allows the cover 28 to move axially toward the element 34 and deeper into the filter head 24 (FIG. 6), which then allows the threaded connection 48 between the head 24 and cover 28 to engage.

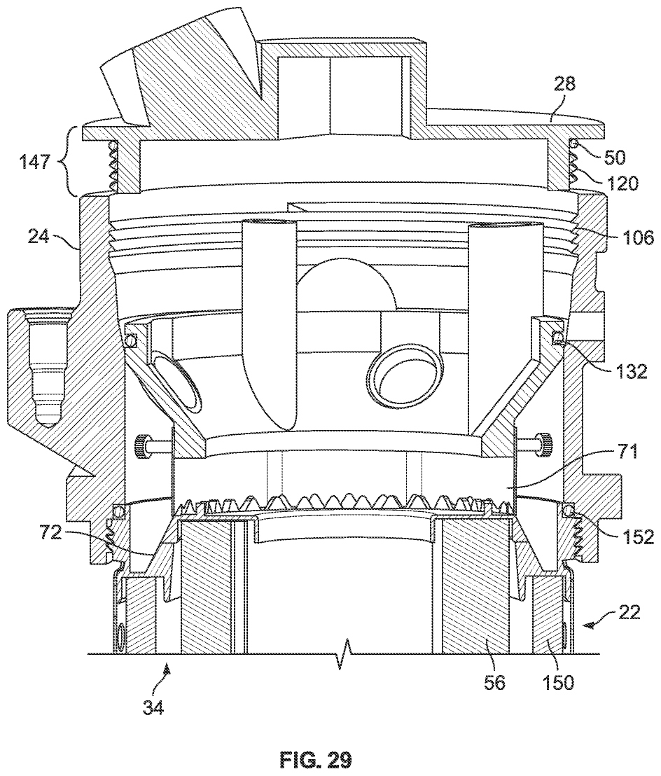

### Alternative Embodiment, FIGS. 29-33

FIGS. 29-33 show an alternative embodiment. While similar to the assembly 20 of FIGS. 22-28, the first abutment member 62 in this embodiment is radially flexible and axially rigid flat spring 71. The flat spring 71 is shaped to form a partial enclosure and thereby includes a gap 73 between terminal ends 71a and 71b (see FIGS. 30 and 32).

The flat spring 71, in the embodiment shown, is a non-circular flex band 71′. In the example shown, the flex band 71′ has a plurality of straight segments 75 which intersect with adjacent segments 75 at vertices 77, forming an open polygon shape with gap 73. While there are many variations possible, in the non-limiting example shown, the open polygon shape is an octagon, having eight segments 75 and gap 73 between ends 71a, 71b.

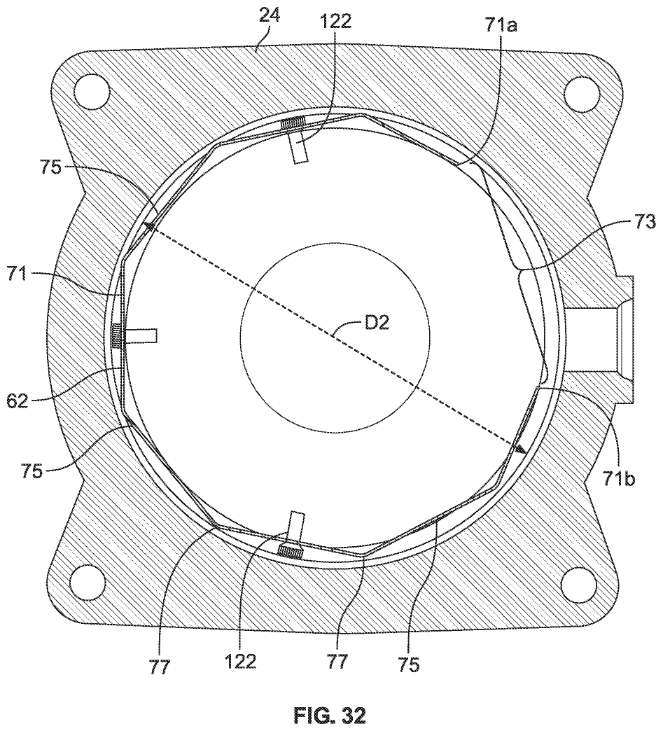

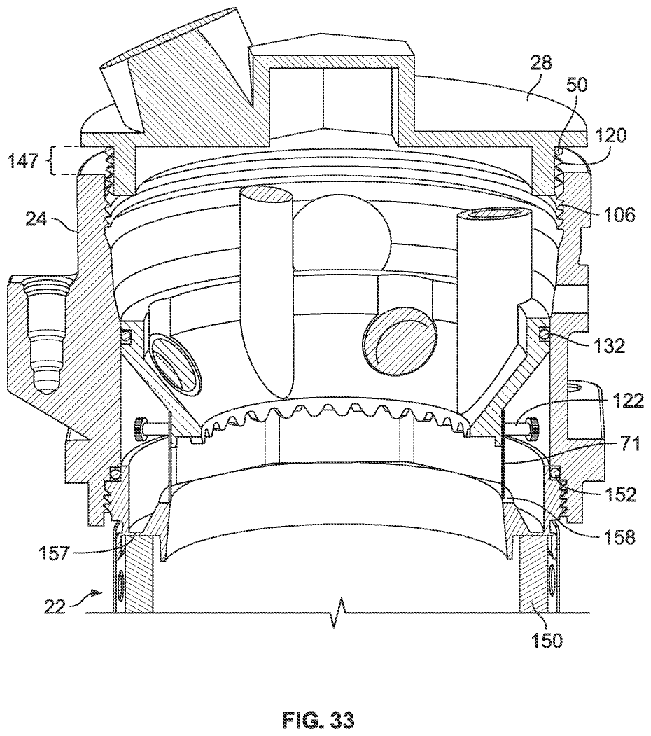

When the assembly 20 moves between the first condition and second condition, the flat spring 71 flexes radially outwardly from the first outmost dimension (FIGS. 30 and 33) to the second (larger) outermost dimension (FIG. 32). This radial flexing increases the distance between ends 71a and 71b, to increase the gap 73.

FIGS. 29 and 30 depict the pre-flex start of engagement between the flat spring 71 and the displacement arrangement 72. The filter cartridge 34 is properly operably installed in the housing 22 with the seal member 150 forming a seal with the filter head 24. In FIG. 29, the cover 28 is initially being lowered into position in the filter head 24. There is engagement between the flat spring 71 and the displacement arrangement 72, which starts to move the flat spring 71 radially outwardly. The space between the cover 28 and head 24 is shown at gap 147b, which is too big for threaded engagement.

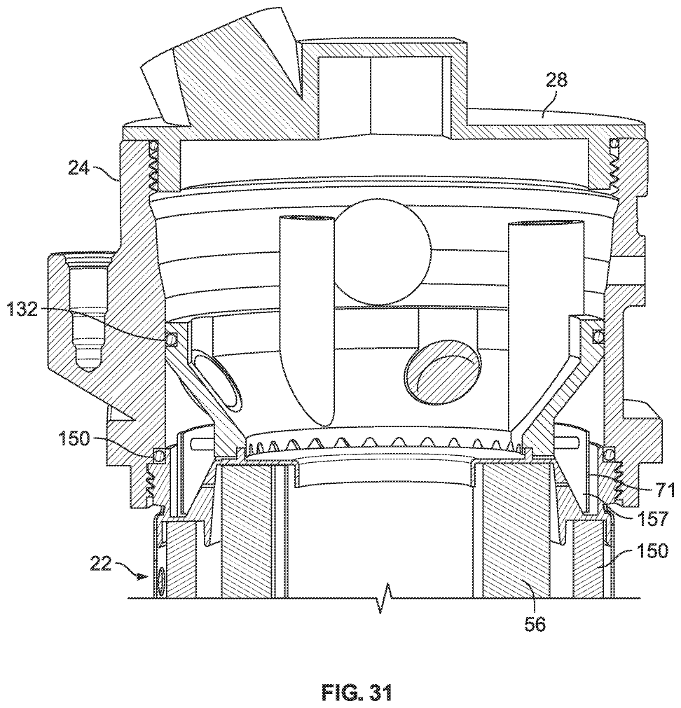

FIGS. 31 and 32 show full assembly. The cover 28 and filter head 24 are connected together, and the seals at 50 and 132 are in place between the cover 28 and filter head 24. The radially flexible and axially rigid flat spring 71 is within the receiving pocket 155 (FIG. 14A) and may be engaged against (or just next to) the engagement surface 157. FIG. 32 shows the radially flexible and axially rigid flat spring 71 at its second (larger) outermost dimension.

As shown in FIG. 33, when there is no filter cartridge 34 installed in the housing 22, there is no transition arrangement 64 to enable transition of the assembly 20 to the second condition. That it, there is no displacement arrangement 72 (FIG. 9) to radially flex the radially flexible and axially rigid flat spring 71, in this example, from a first (smaller) outermost dimension to a second (larger) outermost dimension. As such, an end of the flat spring 71 abuts (engages against) the terminal ends 158 of the extensions 141. When the flat spring 71 abuts the terminal ends 158 of the extensions, the cover 28 is prevented from moving downwardly into the filter head 24; preventing threaded engagement between threads 120 on the cover 28 and threads 108 on the filter head 24, leaving gap 147a therebetween. The seal members 50 and 132 are prevented from forming seals with the filter head 24.

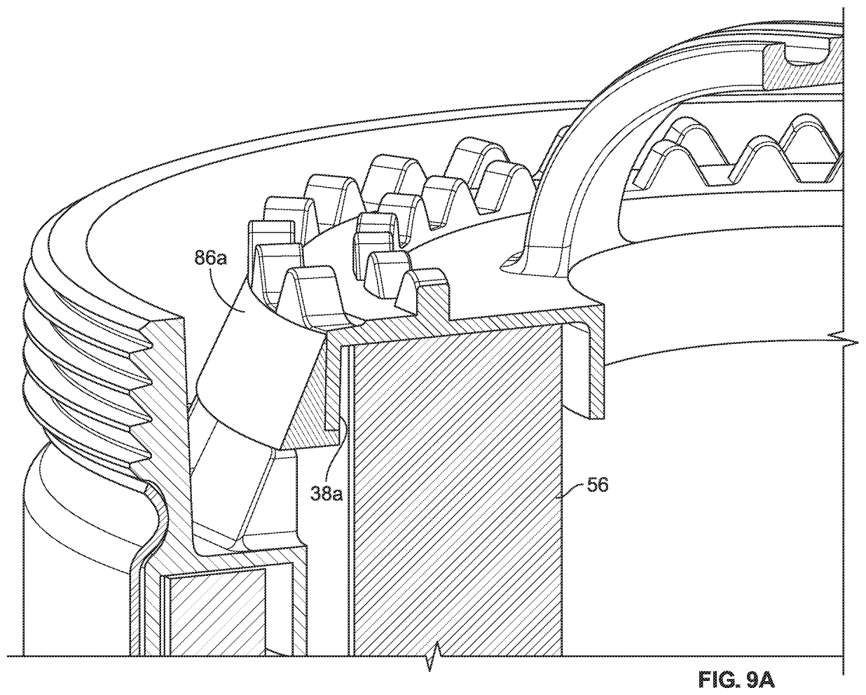

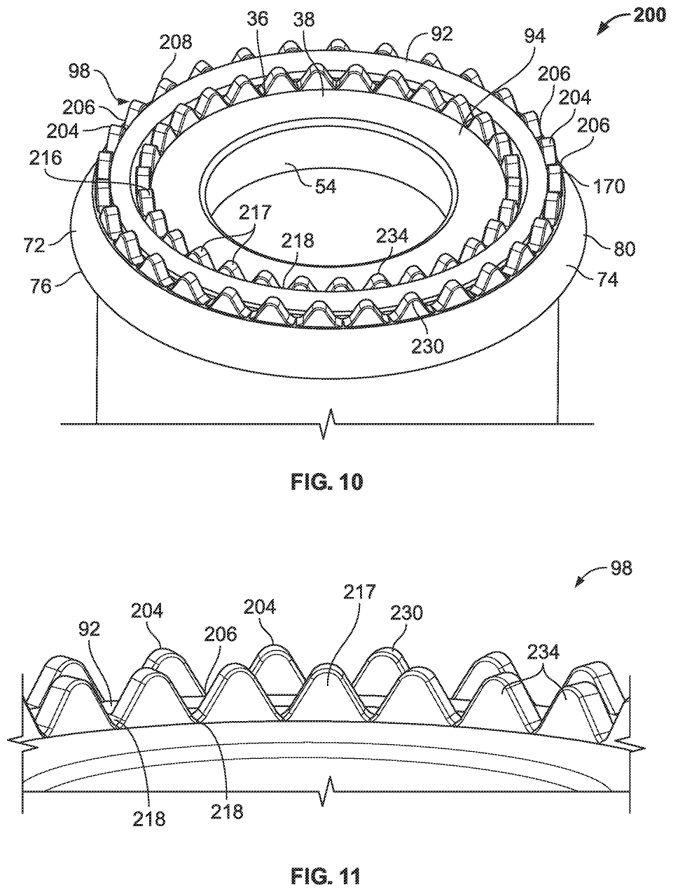

### Example Anti-Rotation Arrangement 98, FIGS. 10, 16, 18, 19

As mentioned above, the assembly 20 can include an optional anti-rotation arrangement 98. The anti-rotation arrangement 98 minimizes or prevents the seal member 92 from bunching or extruding, when the filter cartridge 34 is secured to the filter cover 28.

The anti-rotation arrangement 98 includes a filter element portion 200 that is secured to or integral with the end cap arrangement 36. Typically, and as shown, the anti-rotation arrangement 98, which is the portion 200 on the filter element 34, is an integrally molded part of the first end cap 38.

As shown in FIG. 10, the portion 200 of the anti-rotation arrangement 98 is located on the axial portion 94 of the end cap arrangement 36 adjacent to the seal member 92. Preferably, the anti-rotation arrangement 98 is located in a position to provide at least some lateral support to the seal member 92.

In many preferred implementations, the filter element portion 200 of the anti-rotation arrangement 98 is located between the seal member 92 and an outer periphery 170 or edge of the end cap arrangement 36.

In the example shown, the filter element portion 200 of the anti-rotation arrangement 98 is along the outer periphery 170 of the first end cap 38. The filter element portion 200 of the anti-rotation arrangement 98 can include a plurality of projections 204. The projections 204 can be separated by receivers 206. The projections 204 and receivers 206 form an outer ring 208 circumscribing the seal member 92. When positioned here, the projections 204 are positioned to provide at least some lateral support to the seal member 92, especially when the filter element 34 has filtering flow from inside of the filter media 56 to outside of the filter media 56. If the filtering flow was reversed (i.e., outside to inside), the projections 204 would be provided in a ring inside of the seal member 92.

While many embodiments are possible, each of the projections 204 of the outer ring 208 defines a closed area, while each of the receivers 206 of the outer ring 208 defines an open area. A ratio of the open area to the closed area is 0.2-1.0

In reference now to FIGS. 16, 18, and 19, part of the anti-rotation arrangement 98 can include a filter cover portion 210. The filter cover portion 210 includes a first hub ring 211 of projections 212 and receivers 214. Each of the projections 212 of the first hub ring 211 defines a closed area, while each of the receivers 214 of the first hub ring 211 defines an open area. A ratio of the open area of the first hub ring 211 to the closed area of the first hub ring 211 is 1-1.3.

In many examples, the receivers 206/214 on the element portion 200 and cover portion 210 are positioned and sized to receive the projections 204/212 on the element portion 200 and cover portion 210 and. However, the fit does not need to be exact, and the receivers 206, 214 can be a larger size, shape, and area when compared to the projections 204, 212. Together, the projections 204, 212 and the receivers 206, 214 define a projection and receiver arrangement.

In example embodiments, the projections 204, 212 are circumferentially spaced with receivers 206, 214 therebetween. In some cases, the projections 204, 212 alternate evenly with the receivers 206, 214.

In preferred implementations, the filter element portion 200 further includes an inner ring 216 of projections 217 and receivers 218 radially inward of the seal member 92 such that the seal member 92 is positioned between the outer ring 208 and inner ring 216. The inner ring 216 and outer ring 208 are oriented on axial surface 94 of the first end cap 38 oriented away from the media pack 56. Each of the projections 217 of the inner ring 216 defines a closed area, and each of the receivers 218 of the inner ring 216 defines an open area. A ratio of the open area for the inner ring 216 to the closed area of the inner ring 216 is 0.2-1.0.

The inner ring 216 circumscribes the open aperture 54 in the first end cap 38, in this example. The inner ring 216 is typically radially spaced from the open aperture 54.

Similarly, the cover portion 210 includes a second hub ring 220 of projections 221 and receivers 222 radially inward of the first hub ring 211. When the cover 28 is engaged against the filter cartridge 34, the seal member 92 is between the first hub ring 211 and second hub ring 220. Each of the projections 221 of the second hub ring 220 defines a closed area, and each of the receivers 222 of the second hub ring 220 defines an open area. A ratio of the open area to the closed area of the second hub ring 220 is 1-1.3.

The number of the projections 204, 212, 217, 221 can be equal to each other, different from each other, or some have the same number while others are different. For example, the number of the outer ring 208 of projections 204 can be equal to or different from the number of projections 217 of the inner ring 216. Similarly, the number of the first hub ring 211 of projections 212 can be equal to or different from the number of the secind hub ring 220 of projections 221. The number of the projections 204 can be equal to the number of the projections 212.

The amplitude (height) of the projections 204, 212, 217, 221 can be equal to each other, different from each other, or some be the same while others are different. For example, projections 204 and 217 can be equal or different. The projections 212 and 221 can be equal or different.

The perimeter shape of the projections 204, 212, 217, 221 can be equal to each other, different from each other, or some be the same while others are different. For example, the projections 204, 212, 217, 221 can be cogs 230, 232, 234, 236 having a rectangular shape or a generally triangular shape. The shape of the receivers 206, 214, 218, 222 can be the same or different shape from the projections 204, 212, 217, 221, including generally rectangular or triangular. In addition, the projections 204, 212, 217, 221 and receivers 206, 214, 218, 222 can be wavy-shaped, including a sine wave, for example.

In use, the end cap arrangement 36 of the element portion 200 nests with the first hub ring 211 to rotationally secure the filter cartridge 34 and cover 28.

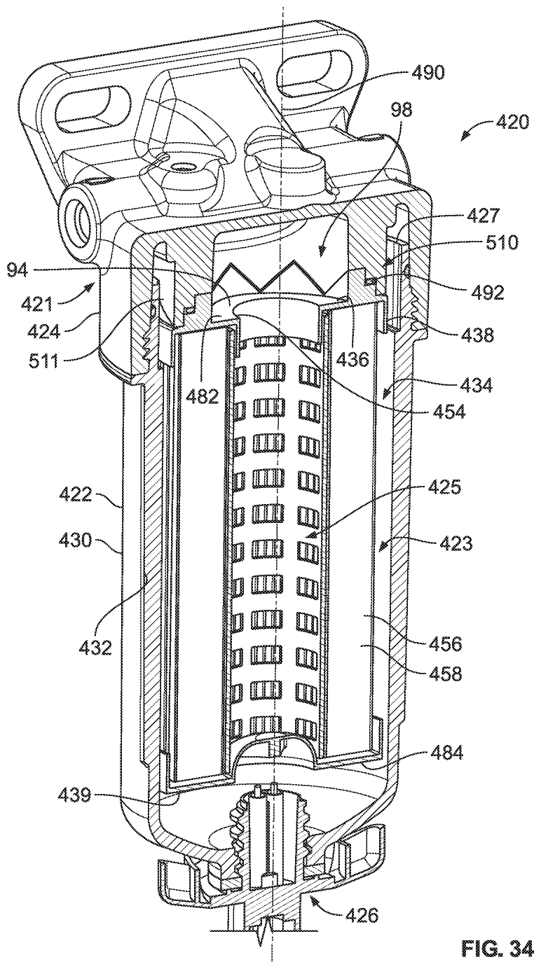

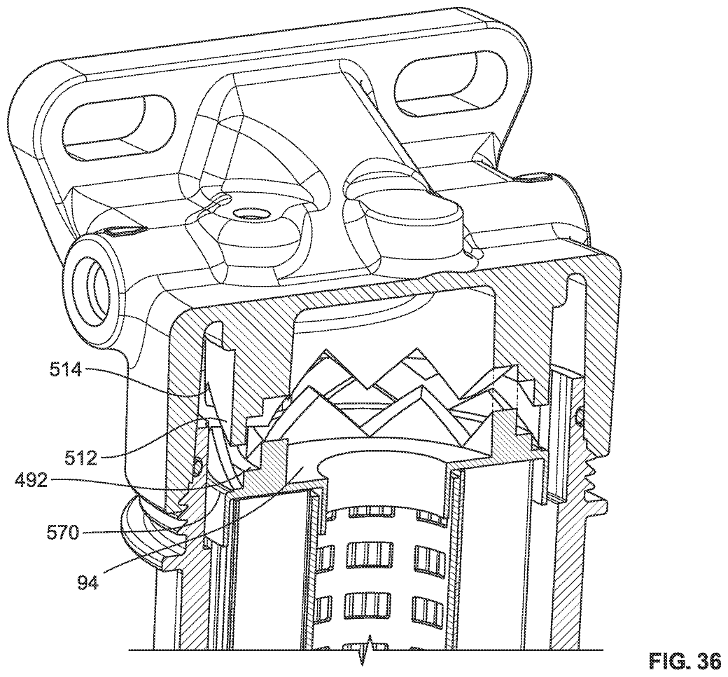

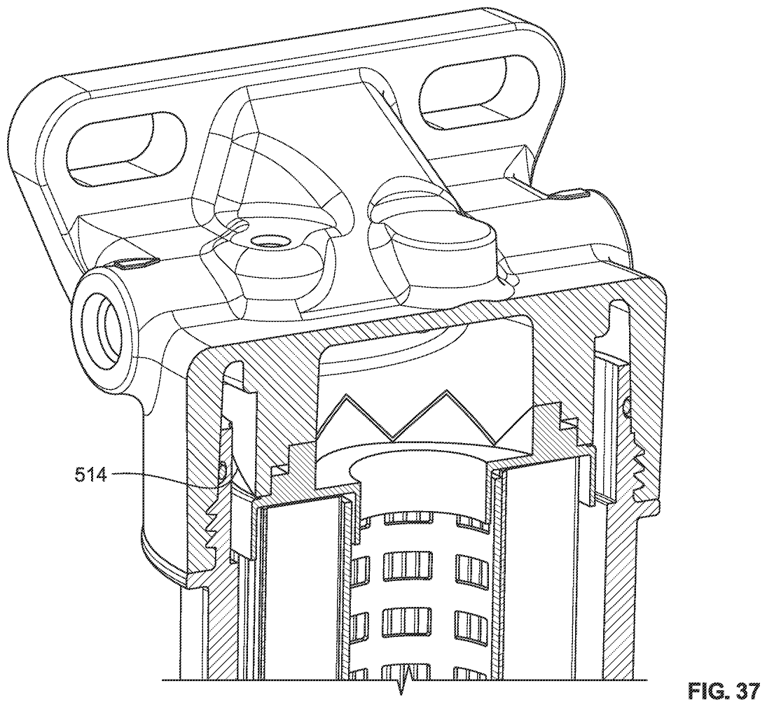

### Example Anti-Rotation Arrangement 98, FIGS. 34-39

FIGS. 34-39 depict another embodiment of a filter assembly 420. The filter assembly 420 includes, operably positioned therein, a serviceable (i.e., removable and replaceable) filter element or cartridge 434. The filter element or cartridge 434 has a first end 482 and opposite second end 484.

An end arrangement 421 is removably positionable over the filter element 434. In the assembly 420, the end arrangement 421 is a filter head 424. Typically, filter head 424 will be a cast member, for example, made from cast aluminum or other material.

The assembly 420 further includes a bowl/housing 422 having a sidewall 430. In use, the sidewall 430 extends (depends downwardly) from filter head 424. In general, the bowl 422 defines an internal volume 432 in which selected internal componentry as defined is contained and certain filtering and flow operations occur. The bowl 422 has an open mouth 427 through which the filter cartridge 434 can be inserted and removed. The open mouth 427 is also the portion of the bowl 422 that releasably connects to the filter head 424. The filter assembly 420 may also be referred to as a bowl-cartridge assembly 420.

The typical serviceable filter cartridge 434 further includes, as described below, an end cap arrangement 436 at the first end 482, which can be embodied as an upper or first end cap 438, which provides for a preferred mounting and sealing of the serviceable filter cartridge 434 to the filter head 424. The second end 484 of the filter cartridge 434 includes a second end cap 439.

The first end cap 438 includes a central aperture 454 for passage therethrough of liquid to be directed either to or from the filter head 424.

The end cap 438 can be molded from a variety of moldable plastic materials, for example, a polyamide (PA). As an example, a glass filled polyamide (15-30% glass filled by wt.) is usable. It can also be formed as a metal piece.

The filter cartridge 434 includes filter media 456, sometimes referred to herein as “media pack 456.” The media 456 can be a pleated media 458 contained within a pleated mesh or similar structure, with pleats extending between the opposite first end cap 438 and second end cap 439.

The media pack 456, as shown in the example embodiments, is generally tubular, and surrounds an open volume. The tubular media pack 456 is depicted as cylindrical in shape. A central longitudinal axis 490 is centered within the media pack 456 and passes through the first end 482 of the cartridge 434 and second end 484 of the cartridge 434.

Typical operation of the assembly 420 of FIG. 34 is generally as follows: The filter head 424 receives dirty fluid (e.g., oil) from an upstream source. The fluid to be filtered flows into the filter head 424 and then into an unfiltered liquid volume 423, which is the volume between the sidewall 430 and the filter media 456. From there, the fluid passes through the filter media 456 (referred to herein as a “filtering flow”), which removes dirt and debris from the fluid. The fluid enters a filtered liquid volume 425, which is within the interior of the media pack 456. From there, the filtered liquid flows through the aperture 454 in the first end cap 438 and into the filter head 424. It exits the filter head 424 for use in the system. The foregoing describes a “forward flow” operation (outside to in). In some cases, the assembly 420 can also operate in a “reverse flow” operation, in which the flow is inside to out.

The second end cap 439 in FIG. 34 is closed. In general, the second end cap 439 can either be closed or open. The assembly 420 of FIG. 34 has a valve assembly 426 in the bowl 422 opposite of the open mouth 427. The valve assembly 426 can be used to drain collected water from the bottom of the bowl 422.

The filter cartridge 434 includes a seal member 492 secured to an axial portion 494 of the end cap arrangement 436 within a plane orthogonal to the central longitudinal axis 490. In the example embodiment shown, the seal member 492 is oriented on the axial portion 494 of the first end cap 438. The seal member 492 forms a seal between the unfiltered liquid volume 423 and the filtered liquid volume 425. The seal member 492 is positioned radially between a radial position of upstream and downstream tips of the pleated media 458.

The assembly 420 includes anti-rotation arrangement 98, provided to minimize or prevent the seal member 492 from bunching, when the filter cartridge 434 is secured to the filter head 424. The anti-rotation arrangement 98 is similar to the arrangement described previously.

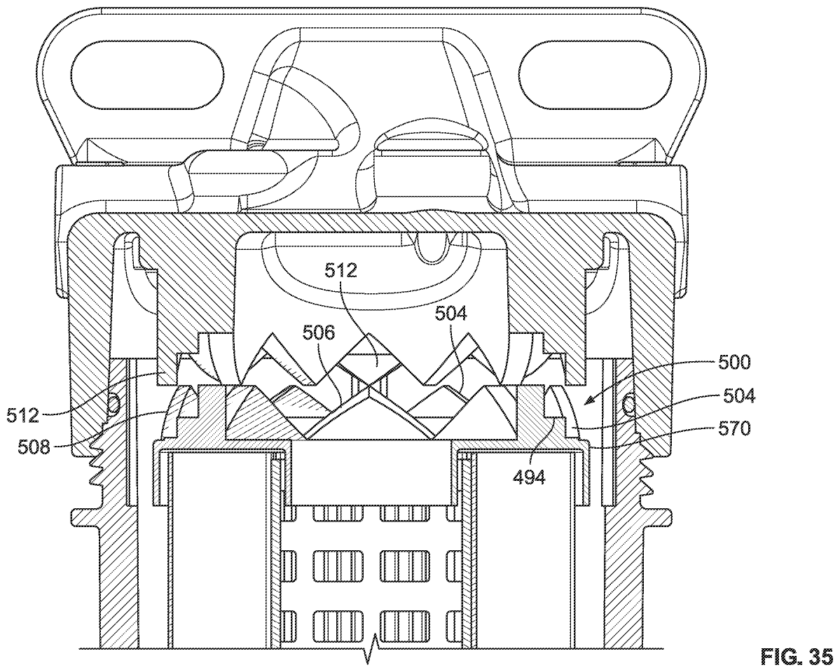

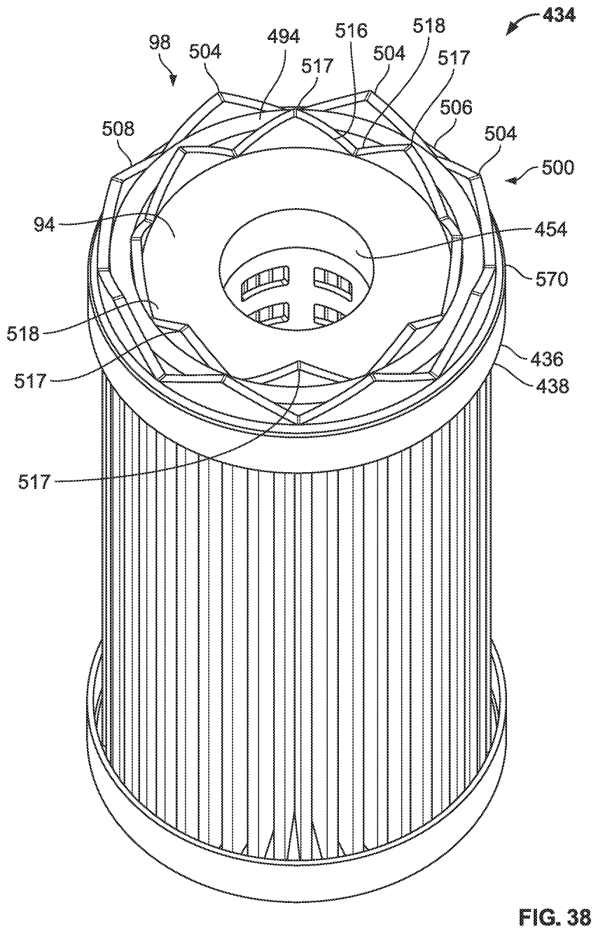

The anti-rotation arrangement 98 includes a filter element portion 500 (FIGS. 35 and 38) that is secured to or integral with the end cap arrangement 436. Typically, and as shown, the portion 500 of the anti-rotation arrangement 98 on the filter element 434 is an integrally molded part of the first end cap 438.

As shown in FIG. 35, the portion 500 of the anti-rotation arrangement 98 is located on the axial portion 94 of the end cap arrangement 436 and adjacent to the seal member 492. Preferably, the anti-rotation arrangement 98 is located in a position to provide at least some radial support to the axial portion 494. It is noted that the seal member 492 is not shown in FIGS. 35 to 38 for purposes of clarity and that the seal member 492 would be present in an actual installation, as is illustrated at FIG. 34. In preferred implementations, the seal member 492 is supported along at least some locations along an inner or outer, or both inner and outer, radial side of the seal member 492.

In many preferred implementations, the filter element portion 500 of the anti-rotation arrangement 98 is located between the seal member 492 and an outer periphery 570 or edge of the end cap arrangement 436.

In the example shown, the filter element portion 500 of the anti-rotation arrangement 98 is along the outer periphery 570 of the first end cap 438. The filter element portion 500 of the anti-rotation arrangement 98 can include a plurality of projections 504. The projections 504 can be separated by receivers 506. The projections 504 and receivers 506 form an outer ring 508 circumscribing the seal member 492. When positioned here, the projections 504 are positioned to provide at least some radial support to the seal member 492, especially when the filter element 434 has filtering flow from inside of the filter media 456 to outside of the filter media 456. If the filtering flow was reversed (i.e., outside to inside), the projections 504 would be provided in a ring inside of the seal member 492.

While many embodiments are possible, each of the projections 504 of the outer ring 508 defines a closed area, while each of the receivers 506 of the outer ring 508 defines an open area. A ratio of the open area to the closed area of the outer ring 508 is 0.2-1.0

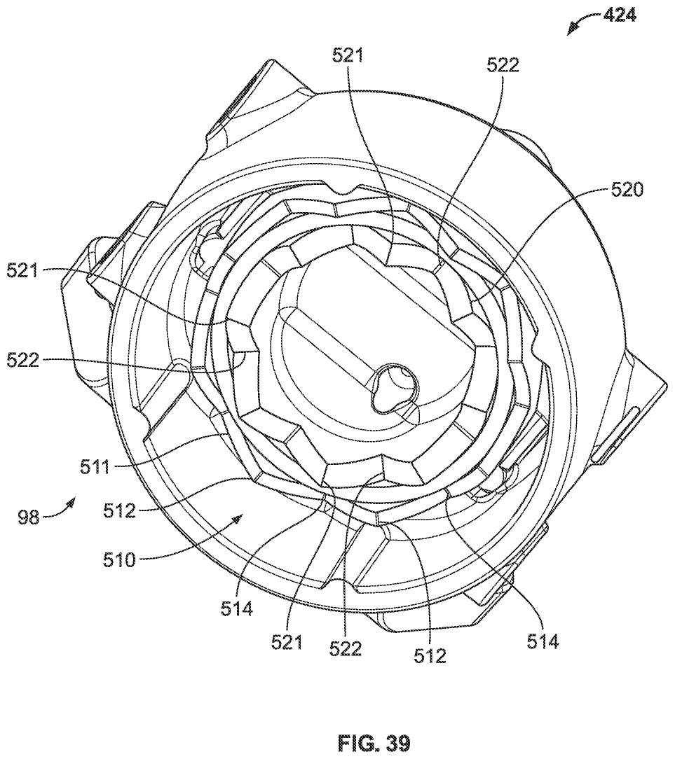

Part of the anti-rotation arrangement 98 can include a filter head portion 510 (FIG. 39). The filter head portion 510 includes a first hub ring 511 of projections 512 and receivers 514. Each of the projections 512 of the first hub ring 511 defines a closed area, while each of the receivers 514 of the first hub ring 511 defines an open area. A ratio of the open area of the first hub ring 511 to the closed area of the first hub ring 511 is 1-1.3.

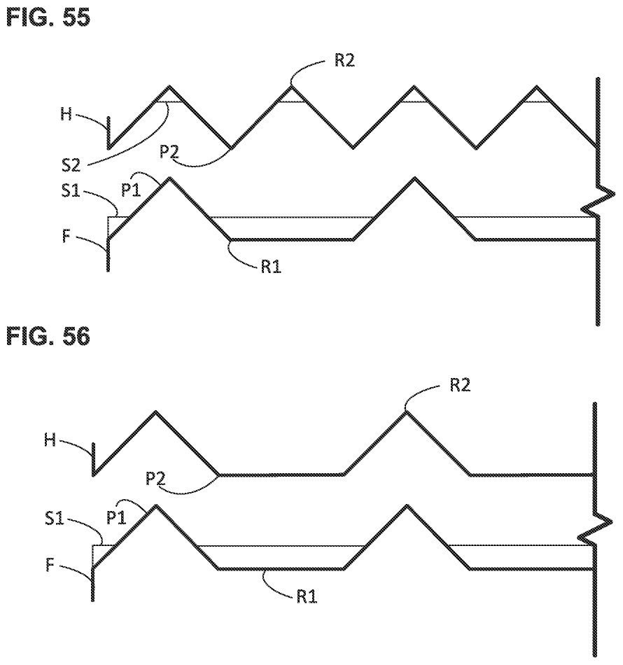

In many examples, projections associated with the element portion 500 are received by receivers on the head portion 510 while projections associated with the head portion 510 are received by receivers on the element portion 500. For example, and as illustrated, the receivers 506/514 on the element portion 500 and head portion 510 are positioned and sized to receive the projections 504/512 on the element portion 500 and head portion 510. However, the fit does not need to be exact, and the receivers 506, 514 can be a larger size, shape, and area when compared to the projections 504, 512, for example, as illustrated later in FIGS. 55-66. Together, the projections 504, 512 and the receivers 506, 514 define a projection and receiver arrangement.

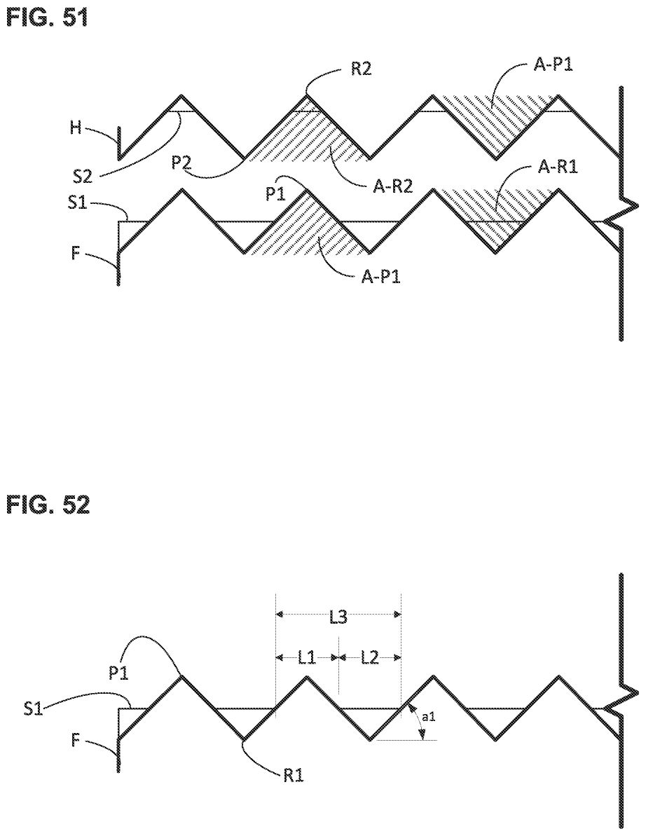

In example embodiments, the projections 504, 512 are circumferentially spaced with receivers 506, 514 therebetween. In some cases, the projections 504, 512 alternate evenly with the receivers 506, 514, as further described later with respect to FIG. 51.

In preferred implementations, the filter element portion 500 further includes an inner ring 516 of projections 517 and receivers 518 radially inward of the seal member 492 such that the seal member 492 is positioned between the outer ring 508 and inner ring 516. The inner ring 516 and outer ring 508 are oriented on axial surface 94 of the first end cap 438 oriented away from the media pack 56. Each of the projections 517 of the inner ring 516 defines a closed area, and each of the receivers 518 of the inner ring 516 defines an open area. A ratio of the open area of the inner ring 516 to the closed area of the inner ring 516 is 0.2-1.0.

The inner ring 516 circumscribes the open aperture 454 in the first end cap 438, in this example. The inner ring 516 is typically radially spaced from the open aperture 454.

Similarly, the head portion 510 includes a second hub ring 520 of projections 521 and receivers 522 radially inward of the first hub ring 511. When the filter head 424 is engaged against the filter cartridge 434, the seal member 492 is between the first hub ring 511 and second hub ring 520. Each of the projections 521 of the second hub ring 520 defines a closed area, and each of the receivers 522 of the second hub ring 520 defines an open area. A ratio of the open area to the closed area of the second hub ring 520 is 1-1.3.

The number of the projections 504, 512, 517, 521 can be equal to each other, different from each other, or some have the same number while others are different. For example, the number of projections 504 of the outer ring 508 can be equal to or different from the number of projections 517 of the inner ring 516. Similarly, the number of the outer hub ring 511 of projections 512 can be equal to or different from the number of the inner hub ring 520 of projections 521. The number of the projections 504 can be equal to the number of the projections 512.

The amplitude (height) of the projections 504, 512, 517, 521 can be equal to each other, different from each other, or some have the same height while others are different. For example, projections 504 and 517 can be equal or different. The projections 512 and 521 can be equal or different.

The perimeter shape of the projections 504, 512, 517, 521 can be equal to each other, different from each other, or some have the same shape while others are different. For example, the projections 504, 512, 517, 521 can be teeth or cogs having a variety of shapes including generally triangular, rectangular, wavy (including sine wave, etc.). The shape of the receivers 506, 514, 518, 522 can be the same or different shape from the projections 504, 512, 517, 521.

In use, the end cap arrangement 436 of the element portion 500 nests with the outer hub ring 511 to rotationally secure the filter cartridge 434 and filter head 424.

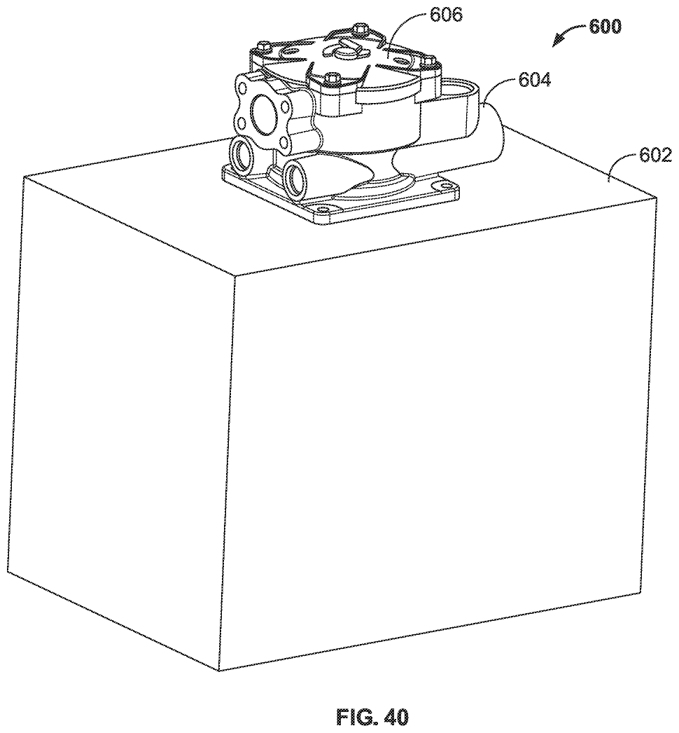

### In-Tank Filter Assembly, FIGS. 40-43

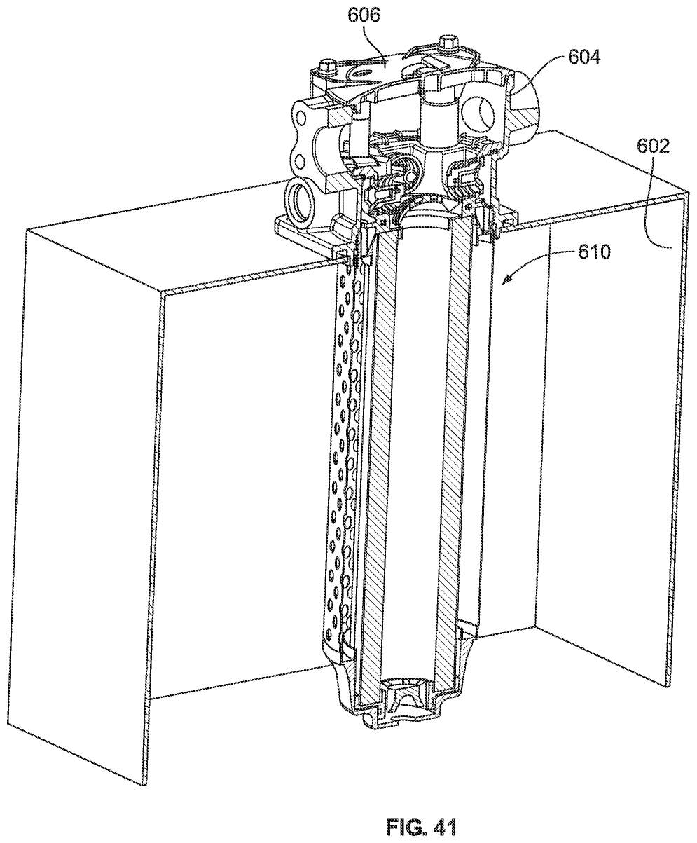

Another embodiment is illustrated in FIGS. 40-43 as an in-tank filter assembly 600, including a tank 602 having a filter head 604 and removable cover 606. A filter cartridge 610 can be seen in FIG. 41 operably mounted within the tank 602 and connected to the filter head 604 and cover 606. The in-tank filter assembly 600 is similar to the assembly 20 of FIG. 5 and a description of the features are not repeated here, but are incorporated by reference.

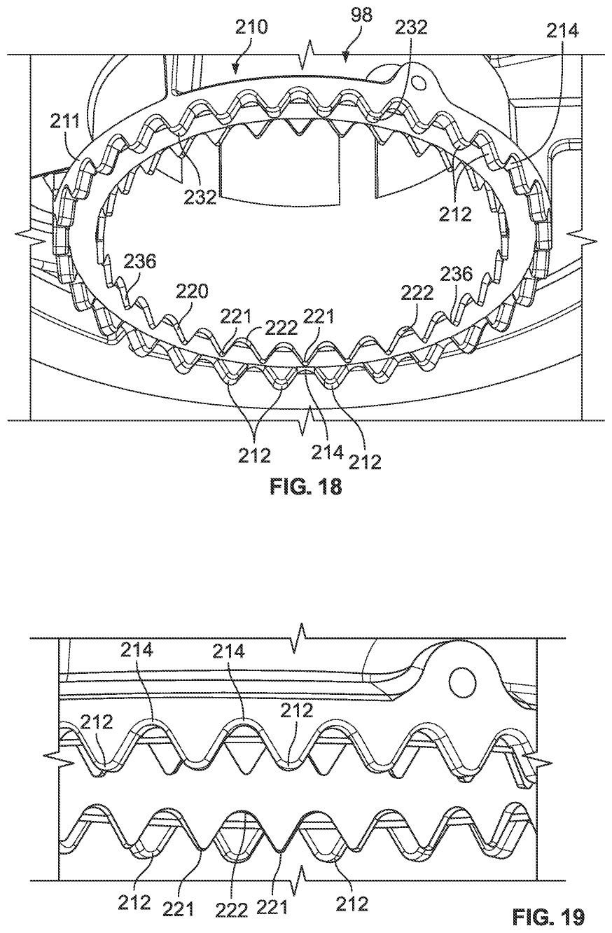

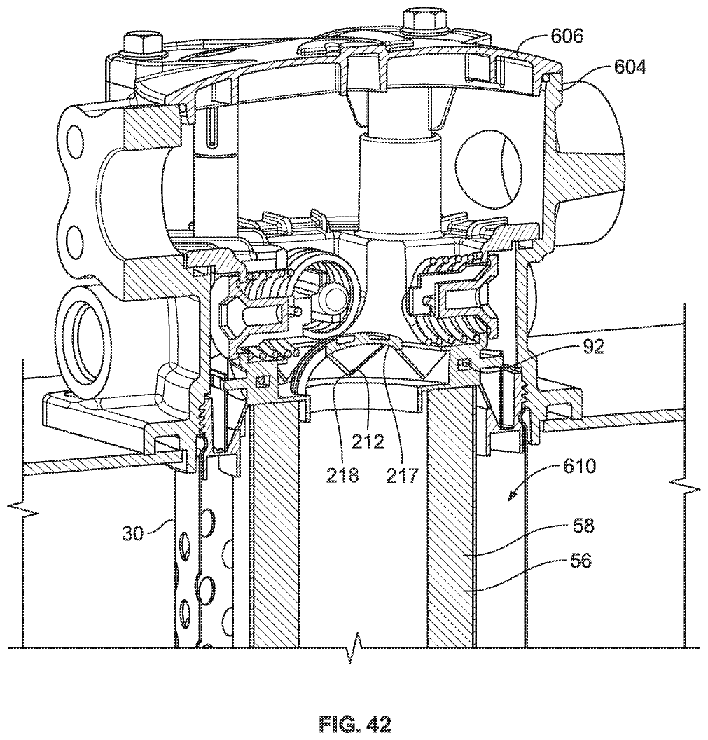

The filter assembly 600 includes axially mounted seal member 92 (FIGS. 42, 43) and includes anti-rotation arrangement 98, provided to minimize or prevent the seal member 92 from bunching, when the filter cartridge 610 is secured to the filter head 604. The anti-rotation arrangement 98 is similar to the arrangements described previously. As such, the anti-rotation arrangement 98 includes, on the filter cartridge 610: alternating projections 204 and receivers 206 forming outer ring 208; and inner ring 216 of projections 217 and receivers 218 radially inward of the seal member 92 so that the seal member 92 is radially between the outer ring 208 and inner ring 216. On the filter cover 606, the anti-rotation arrangement 98 includes: first hub ring 211 of alternating projections 212 and receivers 214; and second hub ring 220 (FIGS. 18, 19) of projections 221 and receivers 222 (FIGS. 18, 19).

In FIG. 43, each of the projections 204, 212, 216, 221 and the receivers 206, 212, 214, 218 are depicted as generally triangular in shape. Other shapes are possible. It is noted that in FIG. 43, certain components, such as the spring, are not shown for illustrative purposes.

### Example Method of Connecting a Filter Assembly

The above components are usable in a method of connecting a filter assembly to a filter end arrangement. The filter end arrangement can be one of a filter head or filter cover. The filter assembly includes a filter cartridge removably mounted in a housing and has a plurality of cartridge projections and receivers positioned to engage the filter end arrangement. The filter end arrangement has a plurality of end arrangement projections and receivers positioned to engage the filter cartridge. The method includes positioning the cartridge projections to be at least partially received within the end arrangement receivers, allowing the filter cartridge to move axially toward the end arrangement. After the filter cartridge moves axially toward the end arrangement, a thread on the housing is engaged with a thread on the end arrangement. The method further includes rotating the housing relative to the end arrangement to threadably connect the filter assembly to the filter end arrangement.

In a further example method, the filter assembly includes a filter cartridge removably mounted in a housing and has a seal member configured for attachment to a filter end arrangement having a plurality of end arrangement projections positioned to radially support the seal member of the filter cartridge. The method includes positioning the cartridge seal member to be at least partially received by the end arrangement projections, allowing the filter cartridge to move axially toward the end arrangement. After the filter cartridge moves axially toward the end arrangement, a thread on the housing is engaged with a thread on the end arrangement. The method further includes rotating the housing relative to the end arrangement to threadably connect the filter assembly to the filter end arrangement.

This method is helpful in ensuring that the projections/receivers on the filter cartridge engage the receivers/projections on the filter head or cover before the mating threads engage. Such an arrangement will minimize the probability that the projections on the filter cartridge and head or cover from binding up and jamming.

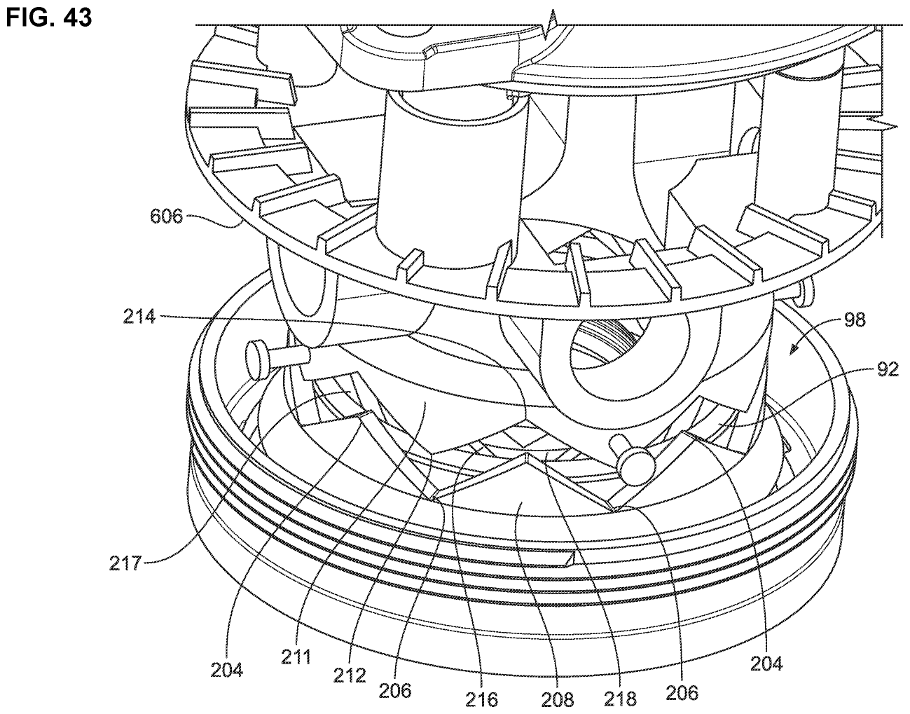

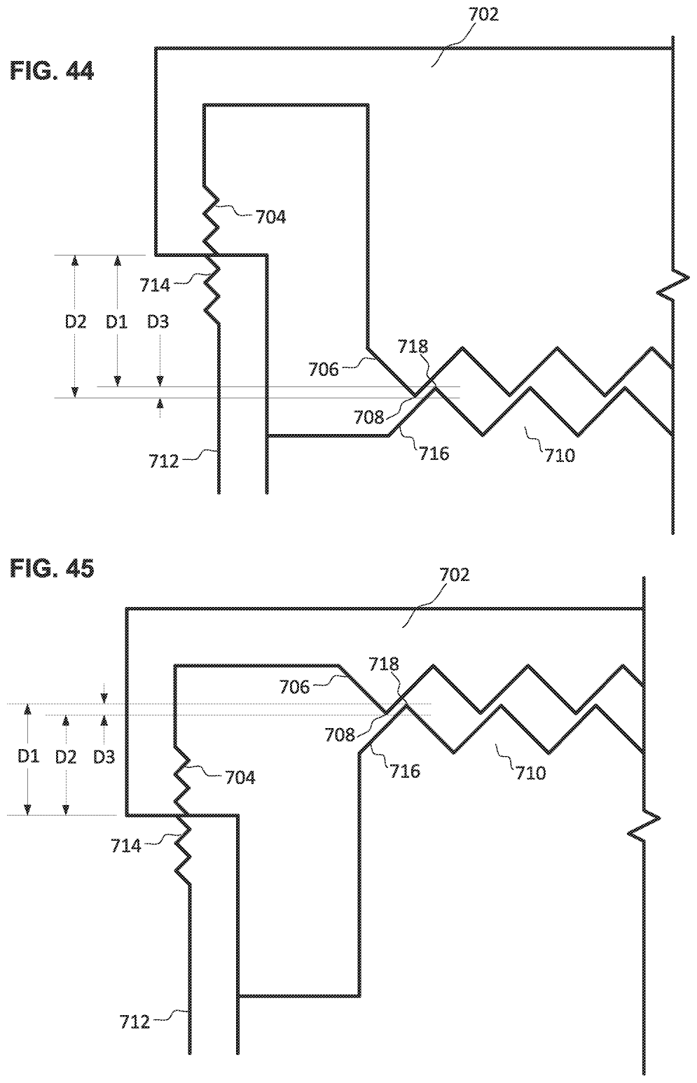

Examples of preferred arrangements are schematically depicted in FIGS. 44-46. In these depictions, the filter head or cover is shown at 702, having threads or threaded section 704, and a plurality of projections 706 with free end tips 708. The cartridge is shown at 710, removable oriented in a housing or bowl 712. The housing or bowl 712 has threads or threaded section 714. The cartridge 710 has a plurality of projections 716 having free end tips 718.

Dimension D1 is the distance measured from the starting point of the threaded section 714 on the housing/bowl 712 to the free end tips 718 of the cartridge projections 716. Dimension D2 is the distance measured from the starting point of the threaded section 704 of the filter head/cover 702 to the free end tips 708 of the projections 706.

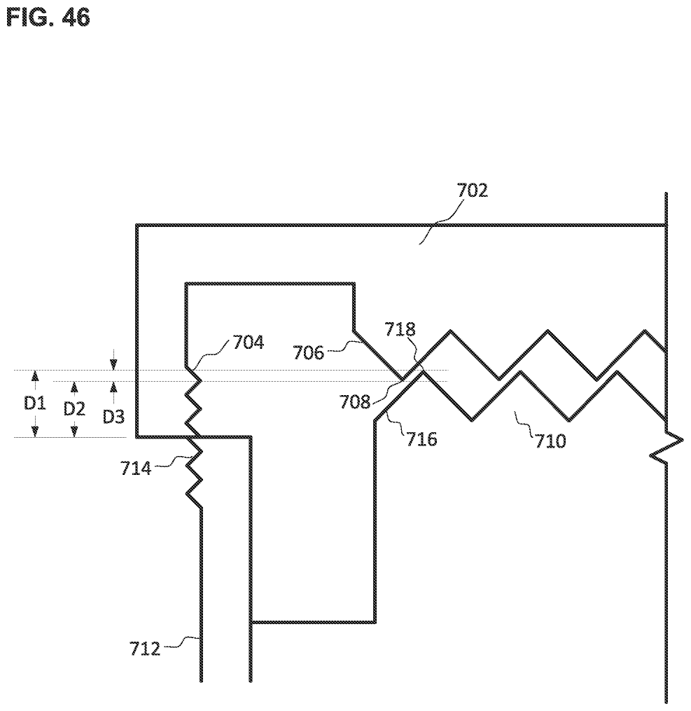

In order to reduce or minimize the possibility of tip-to-tip binding or jamming of the opposing tips 708, 718 during installation, the projections can be arranged such that the tips 708, 718 are moved axially past each other prior to engagement or contact of the threads 704, 718. Such an arrangement can be achieved by making D1 unequal to D2 such that an axial overlap distance D3 results between the tips 708, 718 when the ends of the threads 704, 718 are abutting but not yet engaged. For example, in FIG. 44, a configuration is presented in which the projections 716 on the cartridge 710 are recessed into the bowl/housing 712, wherein D1 is about 0.88 in. and is less than D2, which is about 0.93 in. In another example, in FIG. 45, a configuration is presented in which the projections 706 are recessed into the filter head/cover 702, wherein D1 is about 0.91 in. and is greater than D2, which is about 0.78 in. In yet another example, in FIG. 46, a configuration is shown in which the projections 706, 716 are positioned within a threaded region of the filter head/cover 702, wherein D1 is about 0.31 in., and is greater than D2, which is about 0.26 in. With the above arrangements, the resulting overlap distance D3, which is the difference between D1 and D2, ranges from 0.05 in. to 0.13 in. However, other overlap distances are possible.

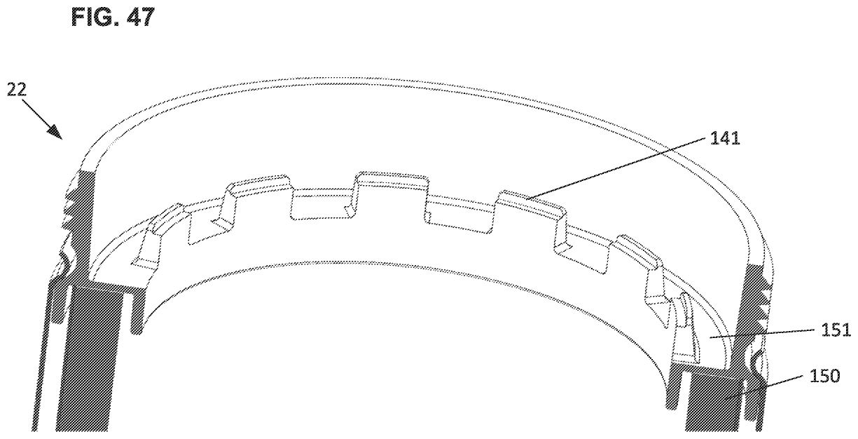

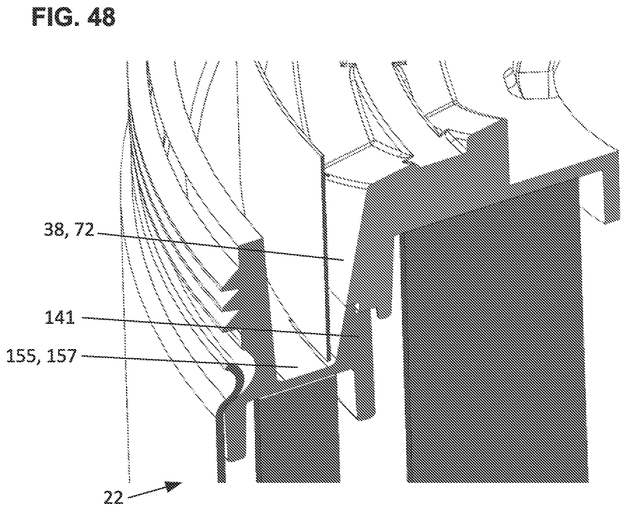

### Alternative Displacement Arrangement and Extension Members of FIGS. 47-50

Referring to FIGS. 47-50, an arrangement using an alternatively configured displacement arrangement 72 and extension members 141 is presented. The features of the arrangements FIGS. 47-50 are primarily shown with respect to the filter assembly embodiment illustrated at FIGS. 34-46, but are not so limited and are also usable with the other embodiments disclosed herein.

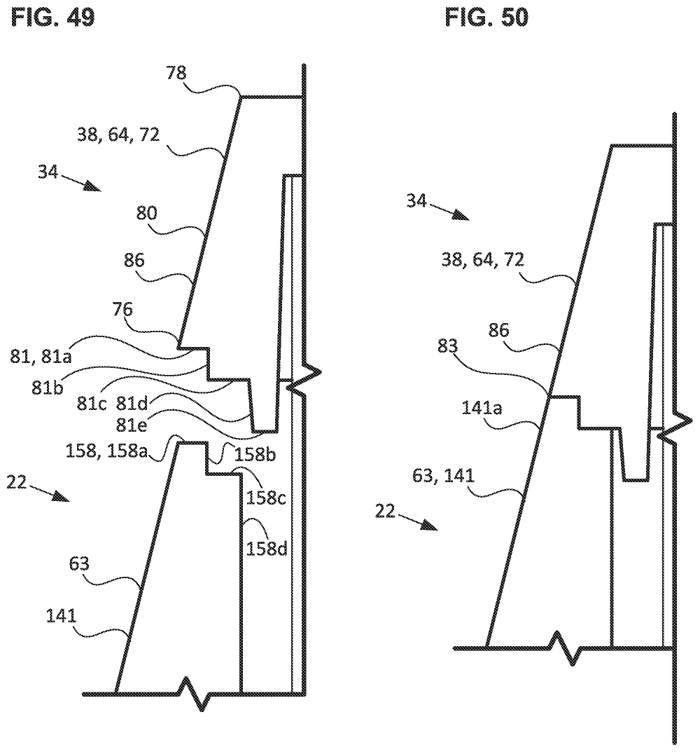

As shown at FIGS. 47-50, and as illustrated in other disclosed embodiments herein, the end construction 151 includes a plurality of axially extending, spaced apart extension members 141 that abut the displacement arrangement 72. In some characterizations, the extension members 141 may collectively be referred to as forming a castellated, crenellation, and/or battlement shape. When the filter element 34 associated with the displacement 72 and the housing 22 associated with the extension members 141 are fully assembled together, open spaces or passageways are formed between the terminal end of the displacement arrangement 72 and adjacent extension members 141. With such an arrangement, bypass flow and case drain flow are permitted through these open spaces. However, in contrast to other previously disclosed embodiments, the extension members 141 are provided with a terminal end 158 that includes a step feature rather than the planar configuration previously shown. This step feature cooperatively interacts with a similarly shaped step feature located on a terminal end 81 of the displacement arrangement 72. As most easily viewed at FIG. 49, the terminal end 158 is provided with axially facing surfaces 158a, 158c and radially inward facing surfaces 158b, 158d forming a first stepped profile while the terminal end 81 is provided with axially facing surfaces 81a, 81c, 81e and radially outward facing surfaces 81b, 81d forming a cooperatively shaped second stepped profile. With such an arrangement, the first and second stepped profiles can engage or couple together such that the surfaces 81a/158a and 81c/158c and 81b, 158b abut each other to form a secure radial and axial connection. Further, surface 81d, which is shown as being provided with a slight taper, is able to act as a guide feature upon initial installation by providing an oblique surface that can interact with the corner formed by surfaces 158c, 158d to center or locate the filter element 34 with respect to the housing 22 such that the first and stepped profiles can be readily engaged at a junction 83. It is noted that the stepped profiles could be switched between the component parts such that the terminal end 81 is provided with radially inward facing surfaces that face radially outward faces provided on the terminal end 158.

In one aspect, the first and second stepped profiles, through their engagement together, ensure that the filter element 34 is precisely located or centered with respect to the housing 22. This feature thus advantageously ensures that the ramp surface 86 of the displacement arrangement 72 is fully aligned with a ramp surface 141a of the extension members about the entire outer circumference of the displacement arrangement 72. As the spring 70 initially slides along ramped surface 86 and then transitions to sliding along ramped surface 141a during installation, it is beneficial to avoid a condition in which any portion of the terminal end surface 158a is exposed or radially outbound of the displacement arrangement 72. Otherwise, such an exposed portion could undesirably act as a catch or abutment surface against the axial end of the spring 70 even though the filter element 34 has been properly installed into the housing 22. It is noted that the ramped surface 141a could be radially inset from the ramped surface 86 to avoid such a potential condition, rather than being perfectly aligned with the ramped surface 86. It is also noted that the angles of the ramped surfaces 86, 141a can be the same or different. While the first and second stepped profiles each include two axial surfaces and one radial surface to essentially form a single-stepped arrangement, additional axial and radial surfaces could be provided to result in a multiple stepped profile. Additionally, it is also possible that only some of the extension members 141 are provided with a stepped profile while others are provided with a planar or other axial end surface at a lower relative height. For example, an arrangement could be provided in which some extension members have the profile shown at FIG. 49 while others are provided with only axial surface 158c, or an even lower surface, defining the terminal end of the extension members.

### Projection and Receiver Arrangement Geometry and Further Examples of FIGS. 51-66

As already discussed above, the filter cartridge projections 204, 217, 504, 517, 716; filter cartridge receivers 206, 218, 506, 518; filter head or cover projections 212, 221, 512, 521, 706; and filter head or cover receivers 214, 222, 514, 522 may be provided with a variety of shapes and arrangements in addition to those already disclosed at FIGS. 1-46. FIGS. 47 to 58 illustrate just some of such possible variations in which filter cartridge projections P1, filter cartridge receivers R1, filter head or cover projections P2, and filter head or cover receivers R2 are schematically presented and usable with any of the projections and receivers shown and described herein. For illustrative purposes, these figures are presented as flat, partial schematics of the projections and receivers.

While many examples are described and disclosed herein, it is noted that some arrangements and configurations may be more preferable or include certain advantages, at least for certain installations. For example, configurations including projections with sharp points can minimize surface contact and beneficially reduce projection-to-projection binding during installation. Further, the sidewalls of the projections and receivers provided with relatively steep sidewalls can induce close to vertical compression while sidewalls provided with relatively shallower sidewalls can help to facilitate alignment between the two opposing pieces. In some configurations, symmetrical projections and receivers with an open to closed area ratio of near 1 are advantageous to assist with meshing and reducing binding between the projections during installation. For a given projection-receiver design, these aspects can be balanced to achieve an optimally performing system.

As indicated previously, the projections and receivers of the filter cartridge and filter head or cover can respectively define closed and open areas. FIG. 51 presents these features schematically as A-P1 and A-R1 for the filter cartridge F and as A-P2 and A-R2 for the filter head or cover H. A seal support surface S1 is also schematically illustrated for the filter cartridge F. In some of the above-described examples, the ratio of the filter cartridge receiver open area to the filter cartridge projection closed area, which can be characterized as being A-R1 to A-P1, is 0.4 to 1.6. However, other ranges are possible. For example, the ratio of A-R1 to A-P1 for the inner and/or outer ring can be, for example, a ratio of 0.2 to 1.8; a ratio of 0.7 to 1.8; a ratio of 0.8 to 1.0; a ratio of 1 to 1.8; a ratio of 1 to 1; a ratio of greater than 1; or a ratio of less than 1. In some of the above-described examples, the ratio of the filter head or cover receiver open area to the filter head or cover projection closed area, which can be characterized as being A-R2 to A-P2, is 0.48 to 1.5. However, other ranges are possible. For example, the ratio of A-R2 to A-P2 for the inner and/or outer ring can be, for example, a ratio of 1 to 1.3; a ratio of 0.2 to 1.7; a ratio of 0.97 to 0.98; a ratio of 1 to 1; a ratio of greater than 1; or a ratio of less than 1. In some configurations symmetrical projections and receivers with a ratio of near 1.0 is advantageous to assist with meshing and reducing binding between the projections P1, P2 during installations.

Referring to FIG. 52, a schematic is presented that illustrates the portions of the seal surface S1 and/or the seal supported thereon that are either supported or unsupported in a radial direction by the projections P1 of either or both of the outer ring OR and the inner ring IR. As shown at FIG. 52, the seal support surface S1 is supported radially by each of the projections P1 over a length L1 and is unsupported by each of the projections P1 over a length L2, wherein the sum of the lengths L1, L2 is equal to the length between a common point between adjacent projections P1. Also shown at FIG. 52 is an angle al which represents the angle between the sidewalls of the illustrated projections P1 and a plane orthogonal to the longitudinal axis of the filter cartridge. In some examples, L1 and L2 are generally equal to each other. In some examples, L1 is greater than L2. In some examples, L2 is greater than L1. The ratio of the unsupported length L2 to the supported length L1 on the filter element can be between about 0.05 and 1.5 in some examples, between about 0.1 and 1.3 in some examples, and/or between about 0.2 and 0.9 in some examples. The ratio of the unsupported length L2 to the supported length L1 on the cover or head side can be between about 0.1 and 1.4 in some examples, between about 0.2 and 1.2 in some examples, and/or between about 0.4 and 0.8 in some examples. In some examples, angle a1 is between 30 degrees and 75 degrees. In some examples, angle a1 is about 60 degrees. In some examples, angle a1 is about 45 degrees.

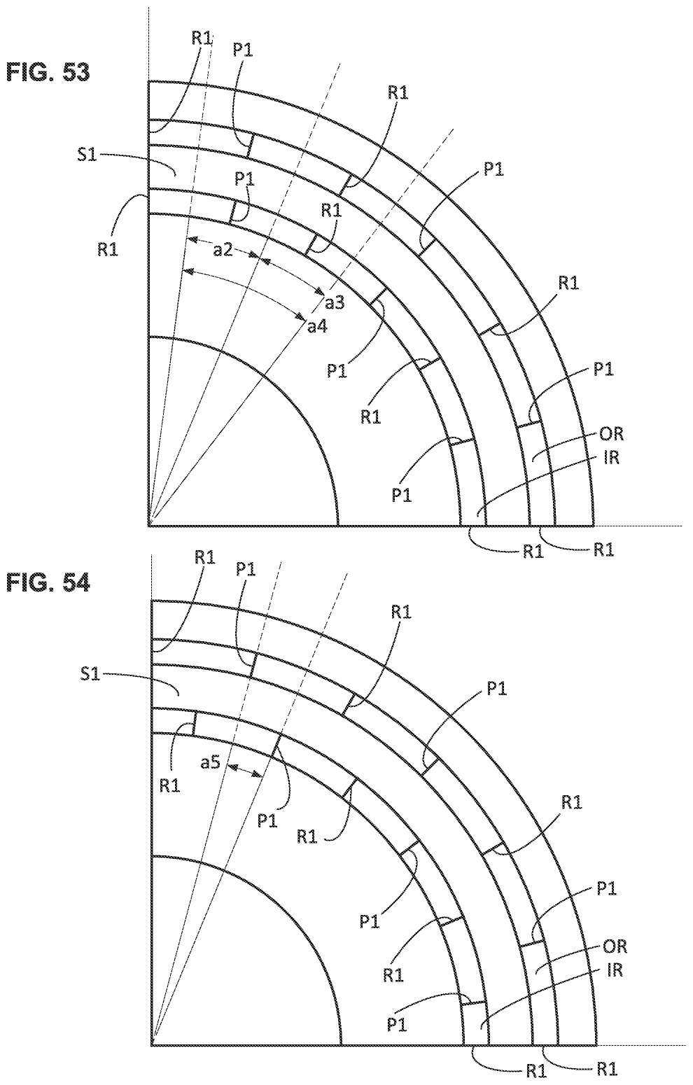

Referring to FIGS. 53 and 54, a top plan schematic view of example projection and receiver arrangements on a filter cartridge showing an outer ring OR with projections P1 and receivers R1, an inner ring IR with projections P1 and receivers R1, and a seal support surface S1 disposed therebetween. With such a view, it can be seen that the supported length L1 corresponds to a radial angle a2, the unsupported length L2 corresponds to a radial angle a3, and the total length L3 corresponds to a radial angle a4. As with L1 and L2, in some examples, a2 and a3 are equal, in some examples, a2 is greater than a3, and in some examples a3 is greater than a2. The ratio of the unsupported length angle a3 to the supported length angle a2 on the filter element and cover or head can be between about 0.25 and 1.75 in some examples, between about 0.5 and 1.5 in some examples, and/or about 1 in some examples. In the example shown at FIG. 53, the peaks of the projections P1 associated with the inner and outer rings IR, OR are radially aligned with each other while in FIG. 54, the peaks of the projections of the inner ring OR are offset by an angle a5 from the peaks of the projections P1 of the outer ring OR. In one example, angle a5 ranges from 0 to 30 degrees. In some examples, a5 is equal to half the angle a4 such that the peaks of the projections of the inner ring IR are radially aligned with the valleys of the receivers R1 of the outer ring OR. Stated another way, the peaks of the projections P1 of the inner ring IR are radially aligned midway between adjacent peaks of the projections P1 of the outer ring OR.

Referring to FIGS. 55 to 66, additional example configurations for the projections and receivers are illustrated. In FIG. 55, an example is provided in which the number or projections and receivers P1, R1 of the filter cartridge F does not match the number of projections and receivers P2, R2 for the filter head or cover H. In the specific example shown, the number of projections and receivers P1, R1 is less than the number of projections and receivers P2, R2, but the reverse is also possible.

Referring to FIG. 56, an example is provided in which the projections P1 and receivers R2 are provided with a different shape in comparison to the projections P2 and receivers R1. In the example shown, the projections P1 and receivers R2 are provided with a triangular shape while the projections P2 and receivers R1 are provided with a trapezoidal shape. The reverse configuration is also possible, as are many other combinations.

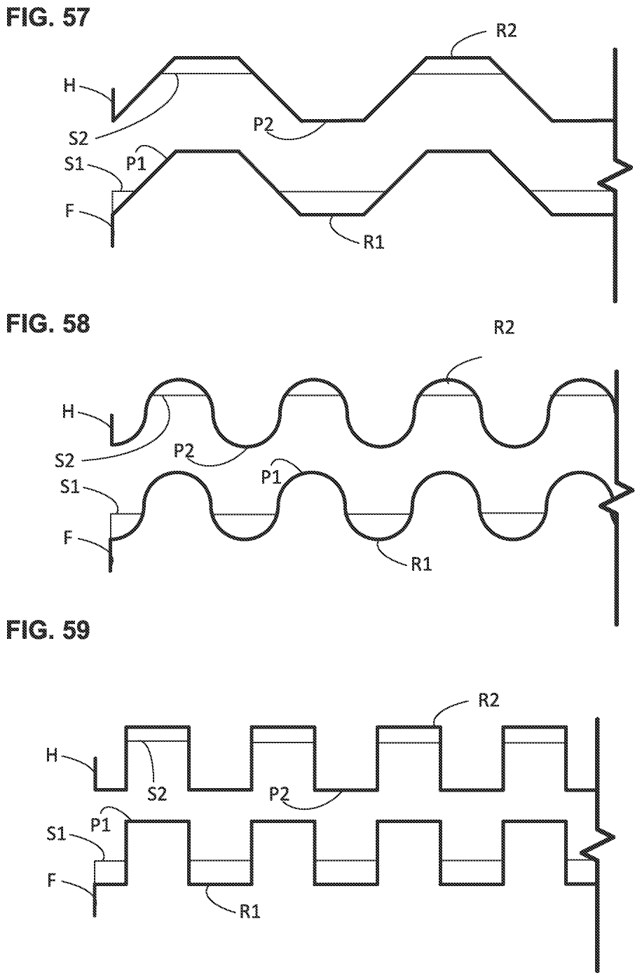

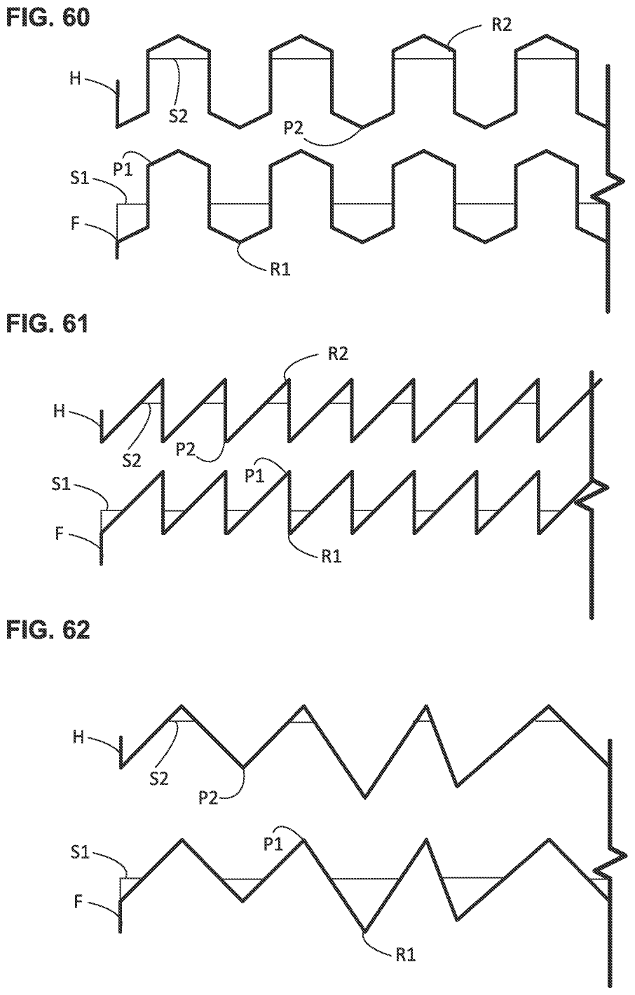

Referring to FIGS. 57 to 60, further examples of possible shapes for the projections and receivers are provided. FIG. 57 shows an example in which the projections P1, P2 and receivers R1, R2 are provided with a trapezoidal shape. FIG. 58 shows an example in which the projections P1, P2 and receivers R1, R2 are provided with a curved, wavy, or sinusoidal shape. FIG. 59 shows an example in which the projections P1, P2 and receivers R1, R2 are provided with a rectangular shape. FIG. 60 shows an example in which the projections P1, P2 and receivers R1, R2 are provided with a rectangular shape with pointed ends. Rounded ends may also be provided. Other configurations and shapes are possible.

Referring to FIG. 61, a configuration is shown in which the projections P1, P2 and receivers R1, R2 are asymmetrically shaped. In the example shown, the projections and receivers are provided with a sawtooth-type shape. Other configurations and shapes are possible.

Referring to FIG. 62, a configuration is shown in which adjacent projections P1, P2 and receivers R1, R2 are different from each other. In the example shown, the projections and receivers have three differently sized and shaped triangles that have different circumferential widths and different axial lengths or depths. More or fewer different shapes and/or sizes can be provided and can be provided in a repeating pattern or in no particular pattern to result in a rotational symmetry ranging from single fold rotational symmetry to as many orders of symmetry as desired.

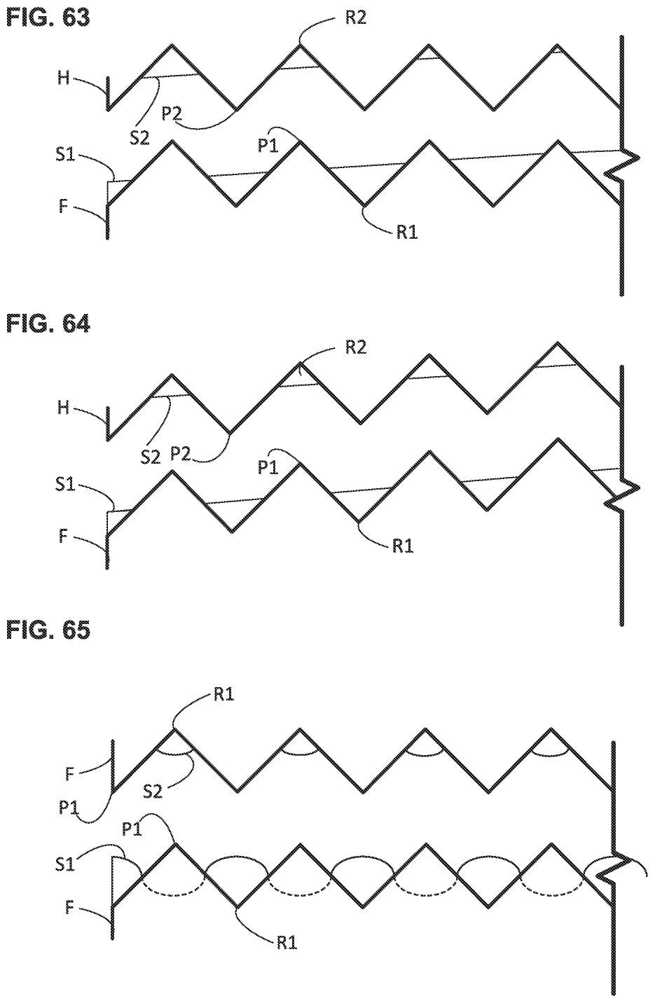

Referring to FIGS. 63 and 64, configurations are shown in which the seal support surface S1 is provided at an oblique angle to the longitudinal axis of the filter cartridge F. FIG. 63 shows a configuration in which the projections and receivers remain arranged along a plane that is orthogonal to the longitudinal axis of the filter cartridge, while FIG. 64 shows a configuration in which the projections and receivers are also oriented at an oblique angle to the longitudinal axis. With such an arrangement, the filter head seal surface would be similarly angled or disposed such that a suitable seal is formed with the obliquely oriented seal member supported by the seal surface S1.

With the configurations shown in FIGS. 62 to 65, it may be that the filter cartridge F can only be received by the cover or head H in a limited number of rotational positions or even only a single rotational position. In such cases, the filter cartridge F and/or cover or head H can be provided with rotational alignment features, including those of the type known in the art. For example, alignment features of the type shown and described in U.S. Pat. No. 11,839,842, entitled Liquid Filter Assemblies; Features; Components; and Methods and issued on Dec. 12, 2023, may be incorporated into the filter assemblies disclosed herein. U.S. Pat. No. 11,839,842 patent is incorporated herein by reference in its entirety.

Referring to FIG. 65, another example is provided in which at least a portion of the seal support surface is provided at an oblique angle to the longitudinal axis of the filter cartridge. In this example, the seal support surface S1 is provided with an axially deviating undulating or sinusoidal shape. Accordingly, a seal mounted to the seal support surface S1 would also be provided with a similar shape. The opposing surface on the filter head against which the seal member forms a seal would also be provided with a similar shape. It is noted that the engagement between the projections P1, P2 ensures that the filter cartridge F can only be installed in one of a number of predefined angular orientations such that the undulating seal member will always align with the undulating seal surface on the filter head to form a suitable seal. In the example shown, the peaks of the seal support surface S1 are aligned with the receivers R1 but may be arranged to align with the peaks of the projections P1. In the example shown, the seal support surface SI has a number of peaks that is equal to the number of projections P1 but may be provided with more or fewer peaks. In the example shown, the seal support surface is provided with a uniform undulating profile but may be provided with an irregular or asymmetric profile as well.

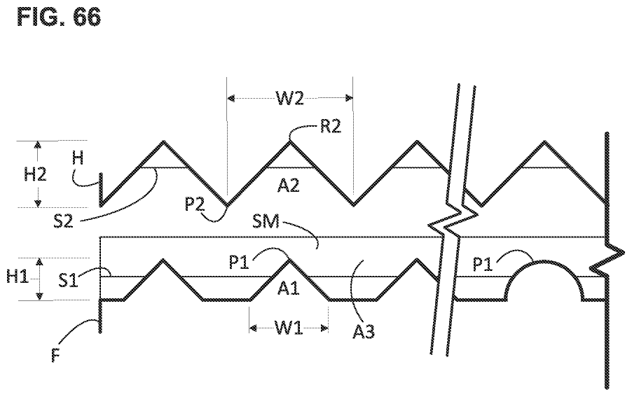

Referring to FIG. 66, an example is provided which illustrates that the projections of the filter element F can have a different size and shape relative to the receivers. In one aspect, the filter element projections P1 have a maximum width W1 and maximum heigh H1 to define a first area A1 while the receivers R2 of the cover or head H have a width W2 and heigh H1 to define an area A2. In the example shown, the height H1 is less than the height H2 while the width W1 is less than the width W2, and the area A1 is less than the area A2. In some examples, the heights H1 and H2 are generally equal while the width W1 is less than the width W2, thereby still resulting in an area A1 that is less than area A2. In some examples, the widths W1 and W2 are generally equal while the height H1 is less than the height H2, thereby still resulting in an area A1 that is less than area A2. As illustrated at FIG. 66, the projections P1 can have a similar or different shape than the receivers. For example, the left side of FIG. 66 shows triangular shaped projections P1 and R1 while the right side of FIG. 66 shows rounded shaped projections P1 and triangular shaped receivers R1. Many other possible combinations of differently shaped receivers R1 and projections P1 are possible as long as the area A1 of the projections P1 remains less than the area A2 of the receivers R1 and provided that the perimeter or boundary edges of the receivers R1 are able to circumscribe the perimeter or boundary edges of the projections P1. In some examples, the ratio of A1 to A2 is between 0 and 1 in some examples, between 0.25 and 0.75 in some examples, and about 0.5 in some examples. In another aspect, the seal material SM can be characterized as having an unsupported area A3 defined as the area of the seal material SM not covered by or otherwise adjacent to the projections P1. In some examples, a ratio of the area A3 to the total radial surface area of the seal member SM, on the side of the projections P1, can be between 0 and 1 in some examples, between 0.25 and 0.75 in some examples, and about 0.5 in some examples. Where the ratio is 1, all support for the seal material SM is provided by the projections P2 associated with the cover or head H as such a configuration would exist in which the projections P1 are either not provided or are non-overlapping with the seal material SM. Although configurations in which the projections P1 have a smaller area than those of the corresponding receivers R2, or in which the projections P1 are not provided or provided at a location where they do not support the seal member, result in less radial support for the seal material SM in an installed condition, such arrangements can still be satisfactory for certain installation and operating conditions. Further, an advantage of providing projections P1 that have a smaller area than that of the corresponding receivers R2 is that less precise initial alignment of between the filter element and cover or may be needed.

The above represents example principles. Many embodiments can be made using these principles.

What is claimed is:

1. A filter assembly comprising:
(a) a filter cartridge having filter media and a first end cap holding an axially disposed seal member;
(b) an end arrangement sized to engage against the filter cartridge and form a seal with the seal member; and
(c) an anti-rotation arrangement constructed and arranged to prevent the filter cartridge and end arrangement from rotation relative to each other.

2. The filter assembly of claim 1, wherein the seal member is supported along at least some locations along an inner or outer, or both inner and outer, radial side of the seal member.

3. The filter assembly of claim 1, wherein the anti-rotation arrangement includes a first assembly on the filter cartridge and a second assembly on the end arrangement.

4. The filter assembly of claim 3, wherein the first assembly of the anti-rotation arrangement includes:
(a) an outer ring of projections and receivers circumscribing the seal member;
(b) wherein each of the projections in the outer ring defines a closed area;
(c) wherein each of the receivers in the outer ring defines an open area; and
(d) wherein a ratio of the open area to the closed area is 0.2-1.

5. The filter assembly of claim 4, wherein the second assembly of the anti-rotation arrangement includes:
(a) a first hub ring of projections and receivers;
(b) wherein each of the projections in the first hub ring defines a closed area;
(c) wherein each of the receivers in the first hub ring defines an open area; and
(d) wherein a ratio of the open area of the first hub ring to the closed area of the first hub ring is 1-1.3.

6. The filter assembly of claim 1, wherein:
(a) the filter cartridge includes a cartridge thread; and
(b) the end arrangement includes an end arrangement thread positioned to rotatably engage the cartridge thread.

7. The filter assembly of claim 6, wherein the first assembly and the second assembly of the anti-rotation arrangements are positioned to engage before the cartridge thread and end arrangement threads engage.

8. The filter assembly of claim 1, wherein:
(a) the filter media includes a cylindrical extension of pleated media surrounding an open filter interior and extending between the first end cap and a second end cap; and
(b) the first end cap has an aperture in communication with the open filter interior.

9. A filter assembly comprising:
(a) an end arrangement including:
(i) a hub having a surrounding wall circumscribing an opening;
(ii) the surrounding wall having a terminal axial surface;
(iii) a hub outer ring of circumferentially spaced projections; and
(b) a filter cartridge having filter media and an end cap arrangement holding a seal member; the end cap arrangement nesting with the hub outer ring to rotationally secure the filter cartridge and the end arrangement.

10. The filter assembly of claim 9, wherein the filter cartridge end cap arrangement includes an outer ring projection arrangement nesting with the hub outer ring of circumferentially spaced projections, the outer ring projection arrangement of the filter cartridge being positioned to radially support the seal member.

11. The filter assembly of claim 9, wherein the hub further includes a hub inner ring of circumferentially spaced projections, the hub inner ring being radially spaced from and surrounded by the hub outer ring.

12. The filter assembly of claim 10, wherein the filter cartridge end cap arrangement includes an inner ring projection arrangement, the inner ring projection arrangement being radially inward of and spaced from the outer ring projection arrangement, wherein the seal member is between the outer ring projection arrangement and inner ring projection arrangement.

13. The filter assembly of claim 10, wherein:
(a) the outer ring projection arrangement on the filter cartridge comprises a plurality of circumferentially spaced outer cogs; and
(b) the inner ring projection arrangement on the filter cartridge comprises a plurality of circumferentially spaced inner cogs;
(c) wherein the outer cogs are sized to nest between the hub outer ring projections, and the inner cogs are sized to nest between the hub inner ring projections.

14. The filter assembly of claim 13, wherein the number of hub outer ring projections is different from the number of spaced outer cogs on the filter cartridge.

15. The filter assembly of claim 9, wherein:
(a) the filter media includes a cylindrical extension of pleated media surrounding an open filter interior and extending between a first end cap and a second end cap; and
(b) the end cap arrangement is an integral one-piece part of the first end cap.

16. The filter assembly of claim 15, wherein:
(a) the first end cap has an aperture in communication with the open filter interior;
(b) the end cap arrangement is on an axial portion of the first end cap and circumscribes the aperture; and
(c) the opening in the hub is in communication with the aperture of the first end cap and the open filter interior.

17. The filter assembly of claim 9, further comprising:
(a) a housing removably holding the filter cartridge, the housing having a housing threaded section; and
(b) the end arrangement having an end arrangement threaded section positioned to be connected to the housing threaded section.

18. The filter assembly of claim 17, wherein:
(a) there is a distance D1 between a start of the housing threaded section and end tips of the projections;
(b) there is a distance D2 between a start of the end arrangement threaded section and end tips of the projections, and
(c) the distance D1 is greater than the distance D2.

19. A method of connecting a filter assembly to a filter end arrangement, the filter end arrangement being one of a filter head or filter cover; the filter assembly including a filter cartridge removably mounted in a housing; the filter cartridge having an axially mounted seal member; the filter end arrangement having a plurality of end arrangement projections positioned to engage the filter cartridge;
the method comprising:
(a) positioning the filter cartridge such that the seal member is at least partially received within the end arrangement projections, allowing the filter cartridge to move axially toward the end arrangement;
(b) after the filter cartridge moves axially toward the end arrangement, engaging a thread on the housing with a thread on the end arrangement; and
(c) rotating the housing relative to the end arrangement to threadably connect the filter assembly to the filter end arrangement such that the end arrangement projections radially support a side of the filter cartridge seal member.

20. The method of claim 19 wherein:
(a) the end arrangement includes a plurality of end arrangement receivers and the filter cartridge includes a plurality of filter cartridge projections, wherein the step of positioning the filter cartridge includes positioning the filter cartridge such that the plurality of filter cartridge projections are received by the end arrangement receivers.
